(19) United States
(12) Patent Application Publication
(10) Pub. No.: US 2026/0332779 A1
(43) Pub. Date: Oct. 22, 2026

(54) ADAPTIVE BITRATE STREAMING OPTIMIZATIONS

(71) Applicant: NETFLIX, INC., Los Gatos, CA (US)

(72) Inventors: Weiguo ZHENG, San Jose, CA (US); Michael Aki SCHASSBERGER, San Ramon, CA (US)

(21) Appl. No.: 19/645,005

(22) Filed: Apr. 10, 2026

Related U.S. Application Data
(60) Provisional application No. 63/789,930, filed on Apr. 16, 2025.

(51) Int. Cl. H04N 19/154; H04N 19/147

(52) U.S. Cl. CPC H04N 19/154; H04N 19/147

(57) ABSTRACT

Techniques are disclosed for optimizing adaptive bitrate streaming using device-side post-processing information. In a profiling stage, encoded test videos are provided to endpoint devices, post-processed video frames are received, perceptual quality information is generated for encoded and post-processed media content, and quality deltas are determined. Based on at least the quality deltas and device information, a device quality profile is generated. In some embodiments, the device quality profile stores lookup values and/or information used to generate a post-processing aware rate-distortion curve and saturation point information. In some embodiments, a predictive model is generated using profiling data associated with the device quality profile to predict quality deltas for encoded representations. During streaming, an endpoint device receives the device quality profile and, in some embodiments, the predictive model determines device-specific perceptual quality information for candidate encoded representations, selects an encoded representation, requests encoded media content, and renders the encoded media content.

### CROSS-REFERENCE TO RELATED APPLICATIONS

The present application claims the benefit of U.S. Provisional Application titled, “TECHNIQUES FOR IMPLEMENTING DEVICE QUALITY PROFILE-BASED ADAPTIVE BITRATE STREAMING OPTIMIZATION,” filed on Apr. 16, 2025, and having Serial No. 63/789,930. The subject matter of this related application is hereby incorporated herein by reference.

### BACKGROUND

### Field of the Invention

Embodiments of the present disclosure relate generally to computer science, streaming and audio processing technologies and, more specifically, to based adaptive bitrate streaming optimizations.

### Description of the Related Art

A streaming platform delivers media content from a remote computing infrastructure to an endpoint device for playback. To support changing network conditions and different endpoint device capabilities, a streaming platform can use adaptive bitrate streaming. In adaptive bitrate streaming, a streaming platform makes available multiple encoded versions of the same media content at different bitrates and resolutions. During playback, a streaming application executing on an endpoint device selects among the encoded versions based on factors such as available bandwidth, playback stability, and endpoint device capabilities.

An endpoint device often performs more than decoding and display of media content. An endpoint device can apply device-side post-processing to media content before display of the media content. Device-side post-processing can include upscaling, sharpening, denoising, edge enhancement, artificial intelligence-based enhancement, and other image improvement operations. As a result, perceptual quality presented by an endpoint device can differ from perceptual quality associated with encoded media content as transmitted by a streaming platform to the endpoint device.

Device-side post-processing introduces various technical problems for adaptive bitrate streaming. A streaming platform commonly selects bitrate and resolution using information associated with encoded media content. However, perceptual quality actually experienced at an endpoint device depends on both encoded media content and device-side post-processing performed by the endpoint device. Different endpoint devices can perform different device-side post-processing operations. Different endpoint devices also can perform device-side post-processing operations at different strengths and under different settings. Accordingly, the same encoded media content can be displayed with different perceptual quality on different endpoint devices.

Because a streaming platform commonly selects bitrate and resolution using information associated with encoded media content rather than information associated with device-side post-processing, bitrate selection and resolution selection can be technically inaccurate for an actual playback environment of an endpoint device. For example, a streaming platform can select a higher bitrate representation and/or a higher resolution representation even when device-side post-processing at an endpoint device would enable a lower bitrate representation and/or a lower resolution representation to provide substantially similar perceptual quality. A streaming platform also can fail to account for variation in perceptual quality caused by differences among endpoint devices, device configurations, and types of media content.

Inaccuracies in bitrate selection and resolution selection produce several technical drawbacks. One technical drawback is inefficient bandwidth utilization because a streaming platform can transmit more data than is necessary to achieve a target perceptual quality at an endpoint device. Another technical drawback is increased load on remote computing infrastructure because higher bitrate media content generally requires greater storage resources, processing resources, transmission resources, and memory resources. Another technical drawback is increased load on an endpoint device because receiving, buffering, decoding, processing, and rendering higher bitrate media content generally consumes additional compute resources, memory resources, and energy. Another technical drawback is reduced playback stability because unnecessary transmission of higher bitrate media content can increase a likelihood of buffering, rebuffering, and other playback disruptions when available bandwidth is limited.

The technical problem is further complicated because device-side post-processing can vary across endpoint device models, endpoint device chipsets, endpoint device firmware versions, endpoint device operating modes, streaming application states, and endpoint device picture settings. As a result, a bitrate selection and/or a resolution selection that is appropriate for one endpoint device can be inefficient or suboptimal for another endpoint device, even when both endpoint devices receive the same media content under similar network conditions. Accordingly, existing approaches can fail to align adaptive bitrate streaming with perceptual quality actually experienced at an endpoint device.

As the foregoing illustrates, what is needed in the art are more effective techniques for selection of bitrate and resolution in streaming platforms.

### SUMMARY OF THE EMBODIMENTS

One embodiment sets forth a computer-implemented method for generating perceptual quality information for one or more endpoint devices. According to some embodiments, the method includes: providing encoded test videos to the one or more endpoint devices; receiving post-processed video frames associated with the encoded test videos from the one or more endpoint devices; generating perceptual quality information based on at least the encoded test videos; generating device-specific perceptual quality information based on at least the post-processed video frames; generating one or more quality deltas based on at least one or more differences between the perceptual quality information and the device-specific perceptual quality information; and generating, based on at least the one or more quality deltas and device information for the one or more endpoint devices, a device quality profile for the one or more endpoint devices.

Other embodiments of the present disclosure set forth a computer implemented method for selecting a representation of media content by an endpoint device. According to some embodiments, the method includes: receiving a device quality profile associated with the endpoint device; obtaining perceptual quality information associated with a plurality of encoded representations of the media content; determining, based on at least the device quality profile and the perceptual quality information, device-specific perceptual quality information for at least one encoded representation of the plurality of encoded representations; selecting, based on at least the device-specific perceptual quality information, a selected encoded representation from the plurality of encoded representations; and requesting encoded media content corresponding to the selected encoded representation.

At least one technical advantage of the disclosed techniques relative to prior approaches is improved accuracy of bitrate selection and resolution selection during adaptive bitrate streaming. The disclosed techniques enable adaptive bitrate streaming to account for device-side post-processing performed by an endpoint device when evaluating perceptual quality of media content. As a result, a streaming platform can select a lower bitrate representation, a lower resolution representation, or both, while maintaining a target perceptual quality at the endpoint device. The disclosed techniques therefore improve bandwidth efficiency because a streaming platform transmits less data to achieve a desired perceptual quality. Improved bandwidth efficiency reduces load on remote computing infrastructure of the streaming platform, including reduced use of compute resources, memory resources, storage resources, and energy for preparation, processing, caching, and transmission of media content. Improved bandwidth efficiency also reduces load on an endpoint device, including reduced use of compute resources, memory resources, buffer capacity, and energy for receiving, buffering, decoding, processing, and rendering media content. In addition, reduced unnecessary selection of higher bitrate representations improves playback stability by reducing a likelihood of buffering, rebuffering, and other playback disruptions. The disclosed techniques also improve device-specific adaptation because the disclosed techniques account for variation in device-side post-processing across endpoint devices, endpoint device configurations, and endpoint device states.

These technical advantages represent one or more technological advancements over prior art approaches.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates a network infrastructure used to execute device profiling and deployment of device quality profiles, according to various embodiments.

FIG. 2 is a more detailed conceptual illustration of the control server of FIG. 1, according to various embodiments.

FIG. 3 is a more detailed conceptual illustration of the endpoint device of FIG. 1, according to various embodiments.

FIG. 4A illustrates a profiling workflow for generation of the device quality profiles and predictive model of FIG. 2, according to various embodiments.

FIG. 4B illustrates example rate-distortion curves, according to various embodiments.

FIG. 5 illustrates a deployment workflow 500 for consumption of the device quality profile and the predictive model during streaming, according to some embodiments.

FIG. 6 illustrates a flow diagram of a method for device profiling, according to various embodiments.

FIG. 7 illustrates a flow diagram of a method for adaptive bitrate streaming using the device quality profile, according to various embodiments.

FIG. 8 is a more detailed illustration of a computing device that can implement the functionalities of any of the entities illustrated in FIG. 1, according to various embodiments.

### DETAILED DESCRIPTION

In the following description, numerous specific details are set forth to provide a more thorough understanding of the present disclosure. However, it will be apparent to one skilled in the art that the present disclosure may be practiced without one or more of these specific details.

As described herein, adaptive bitrate (ABR) streaming enables a streaming platform to deliver media content at different bitrates and resolutions based on changing network conditions and capabilities of an endpoint device. An endpoint device, however, often performs device-side post-processing on media content before display of media content, and device-side post-processing can materially affect perceptual quality experienced at the endpoint device. As a result, bitrate selection and resolution selection based only on information associated with encoded media content can be technically inaccurate for an actual playback environment of the endpoint device. Technical inaccuracy in bitrate selection and resolution selection can lead to inefficient bandwidth utilization, increased load on remote computing infrastructure of a streaming platform, increased load on an endpoint device, and reduced playback stability. The technical problem is further complicated because device-side post-processing can vary across endpoint device models, endpoint device chipsets, endpoint device firmware versions, endpoint device operating modes, streaming application states, and endpoint device picture settings.

To address the foregoing issues, techniques are disclosed for optimization of ABR streaming through incorporation of device quality profiles (DQPs) that compensate for post-processing effects in ABR streaming. A DQP is a dataset specific to one or more endpoint devices, where the DQP is generated through a device testing and profiling stage. The DQP is used to quantify and characterize perceptual quality of media content rendered with post-processing. The DQP can be used as a lookup table to retrieve perceptual information for candidate representations of encoded media content. The DQP can also be used as a source of information to generate or to extract a post-processing aware rate-distortion (RD) curve that reflects perceptual quality values after post-processing across bitrate and resolution combinations. Furthermore, a predictive model can be generated based on profiling data from the DQP to predict a difference in perceptual quality between encoded media content as sent to an endpoint device and encoded media content as rendered with post-processing on the endpoint device for combinations of streaming attributes such as resolution, bitrate, quantization parameters, device settings, and so on.

The disclosed techniques include a device testing and profiling stage and a deployment and streaming stage. In a device testing and profiling stage, media content is rendered on endpoint devices at various bitrates and resolutions with various combinations of post-processing techniques and device settings. Perceptual quality of rendered post-processed media content is measured and compared with perceptual quality of encoded media content sent to endpoint devices. A quality delta is computed as a difference between perceptual quality of rendered post-processed media content and perceptual quality of encoded media content. Data such as quality delta, perceptual quality information, media content information, device settings, and other streaming attributes are used to generate the DQP. The data can also be aggregated and used to generate the predictive model.

In a deployment and streaming stage, the DQP and optionally the predictive model are sent to the endpoint device for incorporation into ABR streaming. The endpoint device evaluates candidate representations of streaming content based on streaming attributes that include bitrate, resolution, quantization parameter, perceptual quality, content features, and device settings. In some embodiments, the endpoint device uses the DQP to determine perceptual quality adjustments associated with candidate representations, where such determination includes determination of a quality delta corresponding to device-side post-processing. The endpoint device combines perceptual quality values associated with the streaming content and the determined quality delta to obtain adjusted perceptual quality values. In some embodiments, the endpoint device uses the DQP to retrieve quality delta. In some embodiments, the endpoint device derives information used to generate a post-processing aware rate-distortion curve from the DQP, where the post-processing aware rate-distortion curve enables bitrate and resolution selection. In some embodiments, the endpoint device derives saturation points for a given bitrate and quality, where saturation points support bitrate and resolution selection. In some embodiments, the endpoint device uses the predictive model to predict the quality delta based on the streaming attributes. The endpoint device selects a representation of bitrate and resolution based on the adjusted perceptual quality values and requests encoded media content corresponding to the selected representation. The endpoint device renders encoded media content using device-side post-processing and outputs rendered media content for display.

At least one technical advantage of the disclosed techniques relative to prior approaches is improved accuracy of bitrate selection and resolution selection during adaptive bitrate streaming. The disclosed techniques enable adaptive bitrate streaming to account for device-side post-processing performed by an endpoint device when evaluating perceptual quality of media content. As a result, a streaming platform can select a lower bitrate representation, a lower resolution representation, or both, while maintaining a target perceptual quality at the endpoint device. The disclosed techniques therefore improve bandwidth efficiency because a streaming platform transmits less data to achieve a desired perceptual quality. Improved bandwidth efficiency reduces load on remote computing infrastructure of the streaming platform, including reduced use of compute resources, memory resources, storage resources, and energy for preparation, processing, caching, and transmission of media content. Improved bandwidth efficiency also reduces load on an endpoint device, including reduced use of compute resources, memory resources, buffer capacity, and energy for receiving, buffering, decoding, processing, and rendering media content. In addition, reduced unnecessary selection of higher bitrate representations improves playback stability by reducing a likelihood of buffering, rebuffering, and other playback disruptions. The disclosed techniques also improve device-specific adaptation because the disclosed techniques account for variation in device-side post-processing across endpoint devices, endpoint device configurations, and endpoint device states.

### SYSTEM OVERVIEW

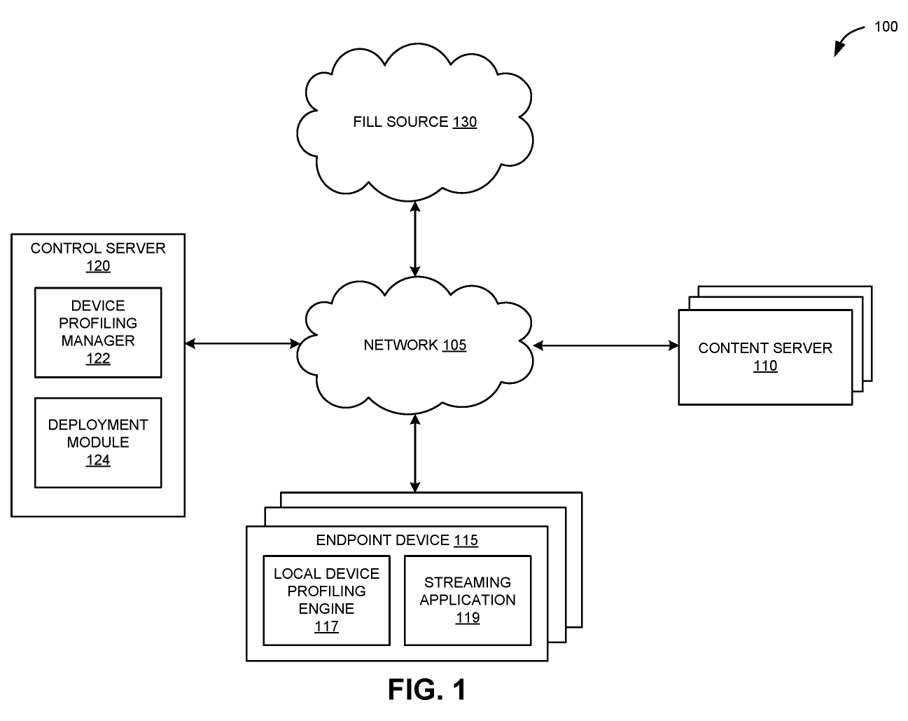

FIG. 1 illustrates a network infrastructure 100 used to execute device profiling and deployment of device quality profiles, according to various embodiments. As shown, network infrastructure 100 includes content servers 110, a control server 120, fill sources 130, and endpoint devices 115, each of which is connected via a communications network 105. Endpoint device 115 includes, without limitation, a local device profiling engine 117 and a streaming application 119. Control server 120 includes, without limitation, a device profiling manager 122 and a deployment module 124.

Each endpoint device 115 communicates with one or more content servers 110 (also referred to as “caches” or “nodes”) via communications network 105 to download content such as textual data, graphical data, audio data, video data, and other types of data. The downloadable content, also referred to herein as a “file,” is then presented to a user of one or more endpoint devices 115. In various embodiments, endpoint devices 115 may include computer systems, set-top boxes, mobile computers, smartphones, tablets, console and handheld video game systems, digital video recorders (DVRs), DVD players, connected digital TVs, dedicated media streaming devices (e.g., the Roku® set-top box), and/or any other technically feasible computing platform that has network connectivity and is capable of presenting content such as text, images, video, and/or audio content to a user. In some embodiments, content can also be received from control server 120. In some embodiments, control server 120 can coordinate and instruct content servers 110 to deliver content to endpoint device 115.

Each content server 110 may include a web server, database, and server application (not illustrated in FIG. 1) configured to communicate with control server 120 to determine the location and availability of various files that are tracked and managed by control server 120. Each content server 110 may further communicate with fill sources 130 and one or more other content servers 110 to fill each content server 110 with copies of various files.

In addition, content servers 110 can deliver content to endpoint devices 115. The files may then be distributed from content servers 110 and/or via a broader content distribution network. In some embodiments, content servers 110 enable users to authenticate (e.g., using a username and password) to access files stored on content servers 110. Although only a single control server 120 is shown in FIG. 1, in various embodiments multiple control servers 120 may be implemented to track and manage files.

In various embodiments, fill source 130 may include an online storage service (e.g., Amazon® Simple Storage Service, Google® Cloud Storage, etc.) in which a catalog of files, including thousands or millions of files, is stored and accessed to fill content servers 110. Although only a single fill source 130 is shown in FIG. 1, in various embodiments multiple fill sources 130 may be implemented to service requests for files. Further, as is well understood, any cloud-based services can be included in the architecture of FIG. 1 beyond fill source 130 to the extent desired or necessary.

Control server 120 operates two workflows. In a device profiling workflow, control server 120 coordinates device profiling of endpoint device 115 and generates a device quality profile and a predictive model. In a device quality profile deployment and streaming workflow, control server 120 deploys the device quality profile and the predictive model to endpoint device 115 during streaming.

Device profiling refers to a process of evaluating how post-processing executed by endpoint devices 115 affects perceptual quality of rendered media content. Deployment refers to distributing the device quality profile and the predictive model to endpoint device 115 for use during adaptive streaming of media content. Adaptive streaming refers to a dynamic selection of a bitrate and a resolution during streaming operations, depending on device settings (e.g., of endpoint device 115) and network bandwidth.

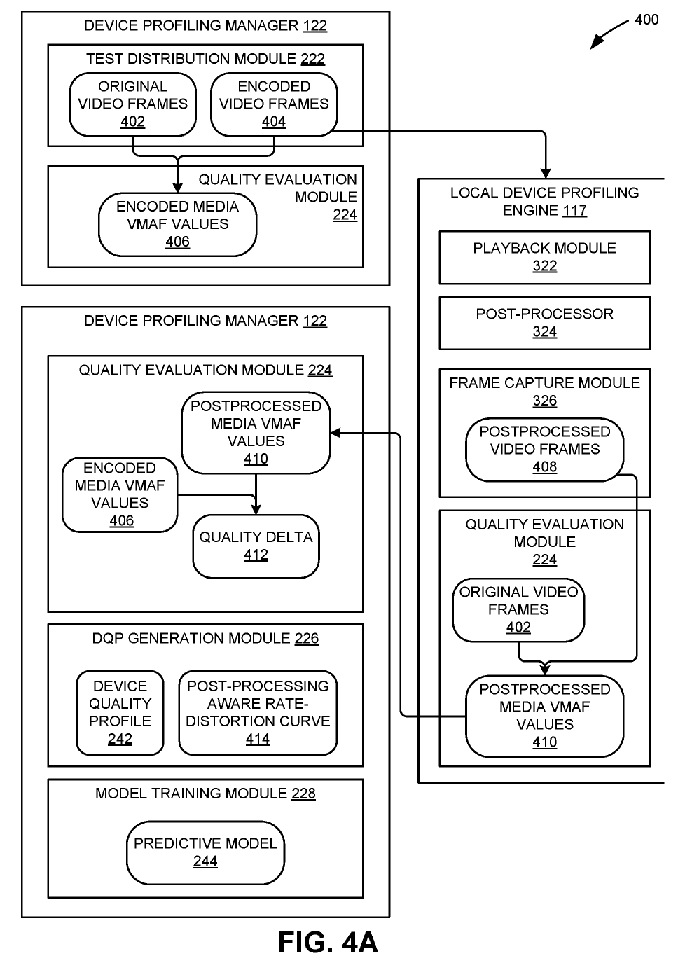

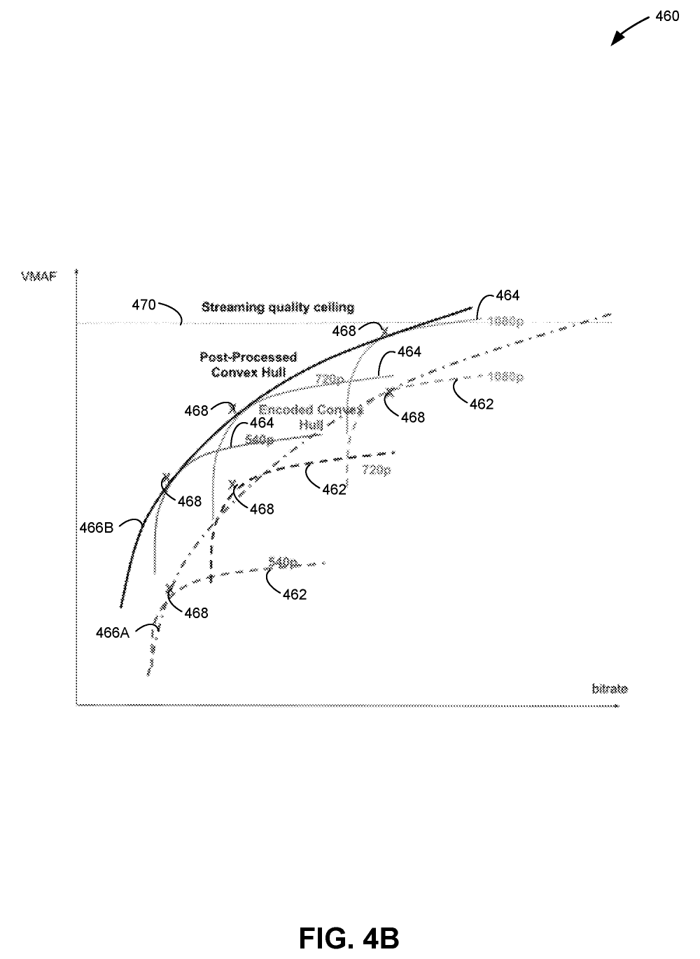

Control server 120 communicates with one or more endpoint devices 115 to distribute media content (e.g., in a form of encoded video frames), receive post-processed video frames and/or perceptual quality of the post-processed video frames, and generate device quality profiles, as discussed in greater detail in conjunction with FIG. 4A. In some embodiments, a control server 120 that performs device profiling can be the same control server 120 that performs deployment of the device quality profiles and the predictive model. In other embodiments, such profiling and deployment operations are performed by different control servers 120.

Device profiling manager 122 is responsible for device testing and profiling of endpoint device 115. In some embodiments, device profiling manager 122 distributes the encoded video frames to endpoint device 115, collects the post-processed video frames, and evaluates the perceptual quality of the post-processed video frames compared to the encoded video frames. Such an evaluation is stored as a quality delta. Device profiling manager 122 uses the quality delta to generate the device quality profile and train the predictive model, as described in greater detail in conjunction with FIG. 4A.

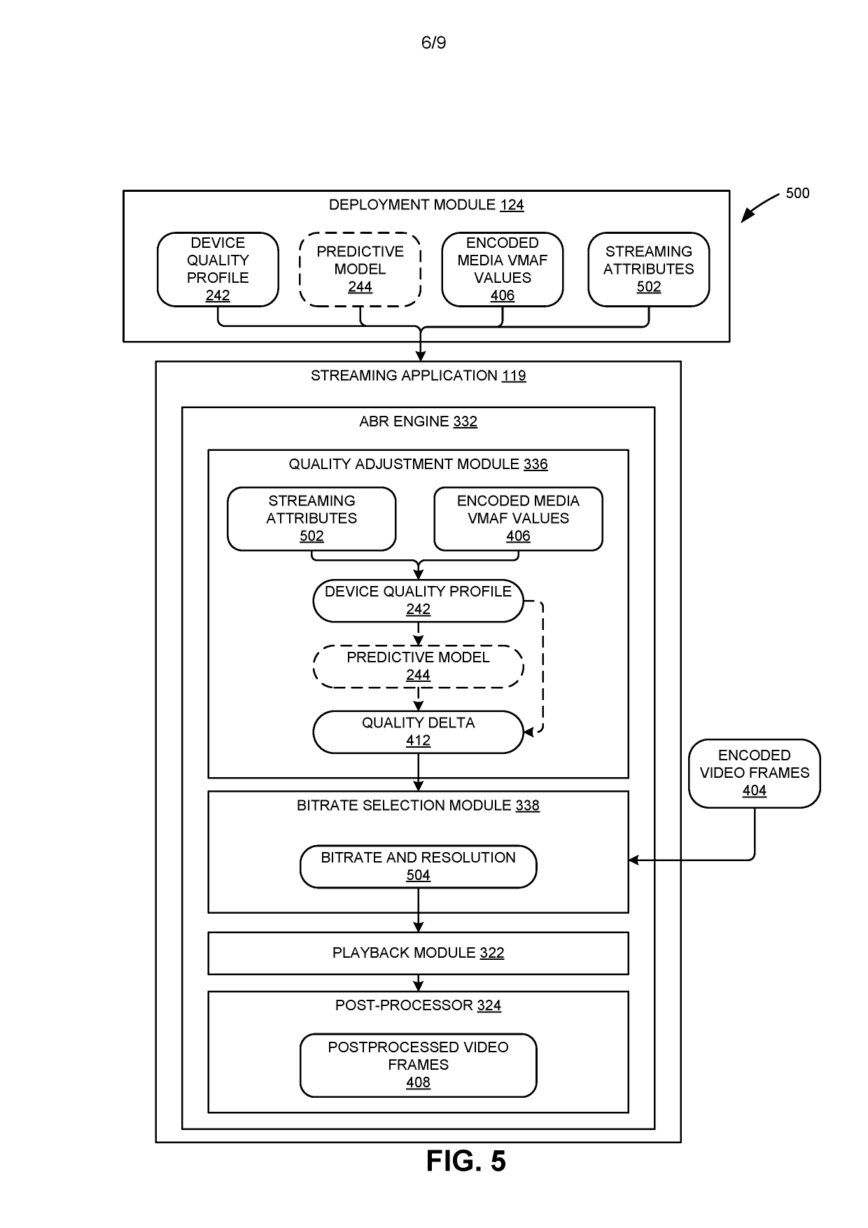

Deployment module 124 distributes the device quality profile and the predictive model to one or more endpoint devices 115. In some embodiments, deployment module 124 deploys the device quality profile and the predictive model to endpoint devices 115 during adaptive bitrate streaming operations so that endpoint devices 115 can adjust bitrate selection and resolution selection, as described in greater detail in conjunction with FIG. 5.

Network architecture 100 illustrated in FIG. 1 is provided for explanatory purposes and is not intended to be limiting. A placement of device profiling manager 122 and deployment module 124 within control server 120 represents one example embodiment. In some embodiments, device profiling manager 122, deployment module 124, or modules thereof can be implemented on content server 110 and/or on other suitable servers. For example, device profiling manager 122 can execute on a server responsible for device testing infrastructure, while deployment module 124 can execute on a server responsible for streaming content (e.g., content server 110). In some embodiments, functionality described with respect to control server 120 can be distributed across multiple server systems, and individual modules can be implemented as separate services or combined within a single server depending on the design of network architecture 100.

Endpoint device 115 operates two workflows. In a device profiling workflow, endpoint device 115 receives media content in a form of the encoded video frames and executes playback, post-processing, and frame capture to generate the post-processed video frames. The post-processed video frames are then analyzed to generate the quality delta. In a deployment and streaming workflow, endpoint device 115 receives media content and executes adaptive streaming during playback of the media content. In some embodiments, endpoint device 115 is a client device of a user.

Notably, endpoint device 115 can include various implementations, including system-on-chips (SOC) based media devices. Endpoint device 115 can be in the form of televisions, mobile devices, set-top boxes, and/or other computing systems capable of rendering and post-processing video content. Different implementations of endpoint device 115 can perform post-processing using different hardware or software pipelines. For example, in some implementations, endpoint device 115 can perform post-processing operations such as upscaling, sharpening, noise reduction, and/or artificial intelligence super-resolution (AISR) using specialized hardware within an SOC or other processor configured for such operations. Other implementations of endpoint device 115 can perform similar operations using software processing pipelines. Because various implementations generate numerous perceptual quality outcomes for the same media content, device profiling is performed so that the device quality profile and the predictive model can compensate for device-specific post-processing behavior during adaptive streaming.

Local device profiling engine 117 renders the media content and enables device profiling operations coordinated by control server 120. Local device profiling engine 117 receives the media content as encoded video frames distributed by control server 120. Local device profiling engine 117 decodes the encoded video frames, applies device-side post-processing, and generates post-processed video frames. In some embodiments, local device profiling engine 117 then transmits the post-processed video frames to control server 120 so that device profiling manager 122 can evaluate perceptual quality of the encoded video frames. In some embodiments, perceptual quality of the encoded video frames is evaluated locally on endpoint device 115 and then transmitted to control server 120.

Streaming application 119 performs adaptive bitrate streaming operations. Streaming application 119 communicates with media servers (e.g., content servers 110 and/or control server 120) to request and play back media content. Streaming application 119 can coordinate buffering of the media content, manage playback state, and execute adaptive bitrate decision making on the media content. During streaming operations, streaming application 119 can utilize the device quality profile and/or the predictive model to adjust perceptual quality estimates used for selecting bitrate and resolution for streaming of the media content.

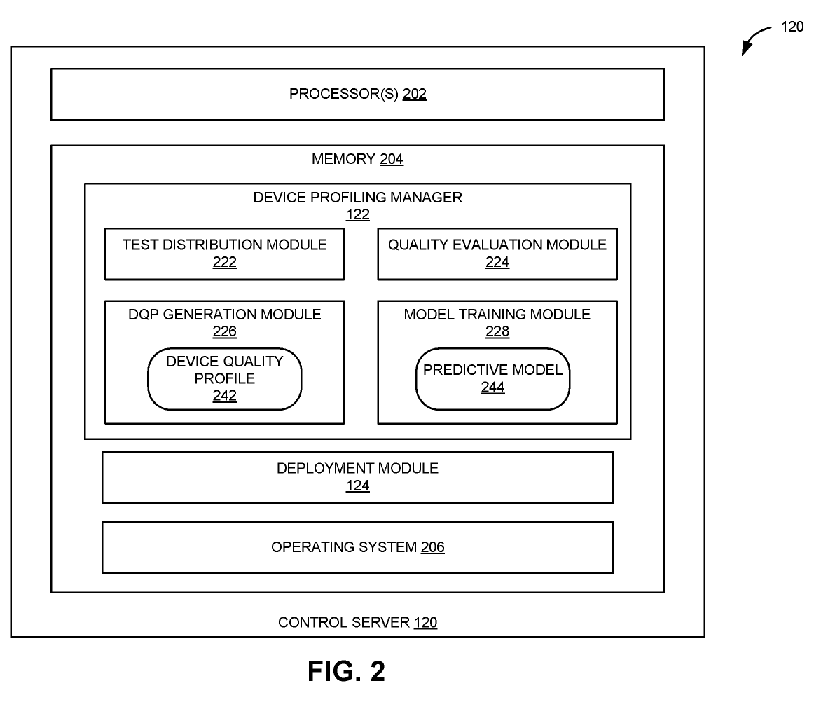

FIG. 2 is a more detailed conceptual illustration of control server 120 of FIG. 1, according to various embodiments. FIG. 2 includes, without limitation, control server 120. Control server 120 includes, without limitation, processor(s) 202 and a memory 204. Memory 204 includes, without limitation, a test distribution module 222, quality evaluation module 224, a device quality profile (DQP) generation module 226, and a model training module 228. DQP generation module 226 generates a device quality profile 242. Model training module 228 generates a predictive model 244.

Processor(s) 202 can be any instruction execution system, apparatus, or device capable of executing instructions. For example, processor(s) 202 can include a central processing unit (CPU), a graphics processing unit (GPU), a controller, a microcontroller, a state machine, a system on a chip (SoC), or any combination thereof.

Memory 204 stores content for use by processor(s) 202. Memory 204 can be one or more readily available memories, such as random access memory (RAM), read-only memory (ROM), a floppy disk, a hard disk, or any other form of digital storage, local or remote. In some embodiments, storage (not shown) can supplement memory 204. Memory 204 can include any number and type of external memories that are accessible to processor(s) 202. For example, and without limitation, memory 204 can include a Secure Digital Card, an external flash memory, a portable compact disc read-only memory (CD-ROM), an optical storage device, a magnetic storage device, or any suitable combination of the foregoing.

Operating system 206 can be any feasible operating system. For example, operating system 206 can include Linux®, Microsoft Windows®, and/or Android™.

Test distribution module 222 distributes encoded video frames to one or more endpoint devices 115 for device profiling. Test distribution module 222 prepares encoded video frames derived from original video frames, where the encoded video frames can be in multiple representations that vary in resolution, bitrate, and content characteristics. For example, the encoded video frames can include representations associated with different resolutions and bitrates, as well as content types such as high-motion scenes, low-motion scenes, and/or texture-rich scenes. In some embodiments, the encoded video frames represent an encoded representation ladder associated with the media content. The encoded representation ladder refers to a collection of encoded representations of the same media content that differ in resolution and bitrate so that streaming application 119 can select among the representations during streaming.

Quality evaluation module 224 evaluates a perceptual quality of the post-processed video frames. Quality evaluation module 224 can input video frames (e.g., the encoded video frames and/or the post-processed video frames) and measure a perceptual quality value of the video frames based on objective metrics. Quality evaluation module 224 can compute perceptual quality using objective metrics including, but not limited to, VMAF, VMAF-NEG, PSNR, and/or SSIM using tools such as FFMPEG or VMAF evaluation frameworks, although other perceptual quality evaluation techniques can also be used. Quality evaluation module 224 can evaluate perceptual quality of the encoded video frames and the post-processed video frames. Quality evaluation module 224 can then compare the perceptual quality associated with the encoded video frames with the perceptual quality associated with the post-processed video frames to generate perceptual quality differences, known as quality delta.

In some embodiments, elements of quality evaluation module 224 or quality evaluation module 224 entirely can operate on endpoint device 115. In such embodiments, instead of transmitting the processed frames to control server 120, endpoint device 115 can compute the objective metrics locally and transmit the objective metrics to control server 120. For example, quality evaluation module 224 can generate perceptual quality values associated with the processed frames on endpoint device 115. Such an approach can reduce bandwidth usage associated with transmission of post-processed video frames.

In some embodiments, quality evaluation module 224 evaluates video frames (e.g., the encoded video frames and/or the post-processed video frames) that include a variety of streaming attributes. For example, quality evaluation module 224 can evaluate the video frames that include streaming attributes such as resolution, quantization parameter (QP), bitrate, device picture quality settings, and other encoding parameters. Quantization parameter values indicate a degree of compression applied to the encoded video frames, where different QP values can introduce different levels of compression distortion. Device picture quality settings correspond to configuration parameters of endpoint device 115 that affect device-side post-processing. The streaming attributes can further include configuration attributes associated with endpoint device 115, including device picture quality settings or post-processing strength values.

In some embodiments, perceptual quality values are stored in a quality map that associates encoded video representations of bitrate and/or resolution with corresponding perceptual quality values. The quality can be generated by evaluating the encoded video frames relative to original video frames using quality evaluation module 224. The quality map can include entries indexed by representation parameters, including bitrate, resolution, and quantization parameter values, such that each representation is mapped to a corresponding perceptual quality value. The quality map can be stored as metadata associated with a representation ladder and used during adaptive bitrate selection. In some embodiments, the quality map represents a baseline rate-distortion relationship for encoded video prior to device-side post-processing. The perceptual quality values can be represented or stored in the quality map. In a streaming or deployment phase, the quality map can constitute input to quality adjustment module 336 for generating adjusted perceptual quality values that compensate for post-processing, based on the quality delta.

In such embodiments, quality evaluation module 224 can associate and organize the video frames with the streaming attributes. For example, quality evaluation module 224 can determine that a first set of post-processed video frames corresponds to a first encoded representation having a first resolution, a first bitrate, and a first QP value, while a second set of post-processed video frames corresponds to a second encoded representation having a second resolution, a second bitrate, and a second QP value. Quality evaluation module 224 can then measure perceptual quality values for the post-processed video frames and compare the measured perceptual quality across combinations of the streaming attributes. By evaluating perceptual quality across the streaming attributes, quality evaluation module 224 can determine how the streaming attributes affect perceptual quality of the media content.

In some embodiments, quality evaluation module 224 groups or indexes perceptual quality values based on the streaming attributes so that perceptual quality can be compared across larger sets of the streaming attributes. For example, perceptual quality associated with a particular resolution and bitrate combination could be compared with perceptual quality associated with another resolution and bitrate combination to determine quality delta caused by the streaming attributes.

In some embodiments, quality evaluation module 224 indexes perceptual quality using a heuristic distortion index derived from the streaming attributes (e.g., encoding parameters and device picture quality settings). The heuristic distortion index represents an estimated measure of distortion or complexity associated with the media content. For example, encoding parameters such as QP values, bitrate allocation, compression settings, and device picture quality settings could indicate how aggressively encoded video frames were compressed or how device-side processing could affect a post-processed video frame. By associating perceptual quality values with the heuristic distortion index, quality evaluation module 224 can categorize perceptual quality values according to estimated frame complexity and distortion characteristics, enabling device profiling manager 122 to more accurately analyze quality delta across multiple encoded representations and device configurations.

DQP generation module 226 generates device quality profile 242. In some embodiments, DQP generation module 226 receives quality delta representing a difference between encoded media content and processed media content generated by quality evaluation module 224.

In some embodiments, DQP generation module 226 aggregates perceptual quality values associated with the streaming attributes of the media content and information corresponding to endpoint device 115. For example, DQP generation module 226 can receive results from quality evaluation module 224 indicating quality delta associated with encoded representations associated with different bitrate and resolution combinations (e.g., from one or more endpoint devices 115), as well as different content characteristics evaluated during device profiling operations. DQP generation module 226 can organize the quality delta into a structured dataset that associates the quality delta with the streaming attributes and settings associated with endpoint device 115. In some embodiments, such a dataset could be represented as a data table that records the quality delta between the encoded video frames and the post-processed video frames across multiple tests evaluated during device profiling operations.

In some embodiments, DQP generation module 226 uses device quality profile 242 to generate a rate-distortion (RD) curve. In some embodiments, DQP generation module 226 encodes information required for ABR engine 332 to generate the rate-distortion curve. In some embodiments, the rate-distortion curve is generated on endpoint device 115 in conjunction with streaming operations. The rate-distortion curve reflects how device-side post-processing executed by endpoint device 115 affects a relationship between bitrate and perceptual quality, as illustrated in FIG. 4B. In some embodiments, the rate-distortion curve is generated based on the perceptual quality values associated with encoded video frames. In some embodiments, the rate-distortion curve is generated based on information stored within device quality profile 242. In some embodiments, the rate-distortion curve is stored within device quality profile 242.

In some embodiments, the rate-distortion curve is post-processing aware such that the perceptual quality values used to generate the post-processing aware rate-distortion curve reflect processed media content after device-side post-processing (e.g., based on the post-processed video frames) rather than the encoded media content sent to the endpoint device 115. As a result, the post-processing aware rate-distortion curve characterizes the perceptual quality that a viewer experiences after device-side post-processing. Such perceptual quality associated with device-side post-processing can be used for determining a selected bitrate and resolution during streaming operations of endpoint device 115. During streaming operations, streaming application 119 can identify saturation points at which additional bitrate yields minimal improvements in perceptual quality due to diminishing returns by analyzing perceptual quality across multiple bitrate and resolution representations. In some embodiments, the post-processing aware rate-distortion curve is included in device quality profile 242. In some embodiments, based on stored information within device quality profile 242, the post-processing aware rate-distortion curve can be extracted or generated.

Device quality profile 242 constitutes collected perceptual quality values associated with settings of endpoint device 115 and combinations of resolutions and bitrates. In particular, device quality profile 242 includes measured quality delta associated with endpoint device 115 and various streaming attributes (e.g., various encoding and content conditions). For example, device quality profile 242 could store quality delta measured across multiple bitrate and resolution representations and across different content types. By associating quality delta with the streaming attributes, device quality profile 242 characterizes how device-side post-processing and other streaming attributes associated with endpoint device 115 affect perceptual quality of processed media content.

In some embodiments, device quality profile 242 provides direct quality delta as lookup values. When endpoint device 115 evaluates a candidate representation having a given bitrate, resolution, quantization parameter, and/or device setting state, endpoint device 115 retrieves a corresponding quality delta from device quality profile 242. In such embodiments, predictive model 244 is not required. ABR engine 332 combines perceptual quality values associated with encoded media content with the retrieved quality delta to determine an adjusted perceptual quality value for the candidate representation. ABR engine 332 selects bitrate and resolution based on the adjusted perceptual quality value.

In some embodiments, device quality profile 242 provides information used to generate a post-processing aware rate-distortion curve. Device quality profile 242 can store or encode information sufficient to derive a device-specific rate-distortion relationship that reflects perceptual quality after device-side post-processing. In such embodiments, ABR engine 332 utilizes the post-processing aware rate-distortion curve from device quality profile 242 without computing the post-processing aware rate-distortion curve independently and determines perceptual quality behavior across bitrate and resolution combinations using device quality profile 242.

In some embodiments, device quality profile 242 can store information corresponding to saturation points and information corresponding to a quality ceiling. The saturation points correspond to bitrates for a given resolution at which increases in bitrate result in diminishing improvements in perceptual quality. The quality ceiling corresponds to a maximum perceptual quality achievable for a given resolution or device. Therefore, the saturation points and the quality ceiling correspond to two independent yet interrelated concepts. The saturation points indicate where perceptual quality begins to plateau, and the quality ceiling represents an upper bound of perceptual quality that can be achieved. Device quality profile 242 can store a bitrate threshold or saturation points indicating that increases in bitrate beyond the bitrate threshold yield minimal quality delta. ABR engine 332 uses the saturation points from device quality profile 242 to avoid selecting higher bitrate representations when perceptual quality gains are negligible, which advantageously improves bandwidth efficiency.

In some embodiments, device quality profile 242 is partitioned into ranges associated with device states, streaming attributes, and/or post-processing configurations. Endpoint device 115 utilizes the partitioned device quality profile 242 as a lookup structure to determine perceptual quality information for candidate representations.

Model training module 228 trains predictive model 244 using device quality profile 242 and the streaming attributes. Predictive model 244 is used to predict the quality delta introduced by device-side post-processing executed by endpoint device 115. Predictive model 244 receives the streaming attributes, device quality profile 242, and in some embodiments a perceptual quality of the encoded video frames, and generates a prediction of the quality delta associated with the post-processed media content generated by endpoint device 115 compared with the encoded media content (e.g., the encoded video frames). In some embodiments, predictive model 244 predicts the quality delta for a combination of the streaming attributes (e.g., resolution, bitrate, QP, device configuration, device picture quality settings, post-processing strength values, etc.). Based on the streaming attributes and device quality profile 242, predictive model 244 estimates the quality delta expected after device-side post-processing.

Notably, predictive model 244 is configured to generalize perceptual quality behavior across streaming conditions beyond entries stored in device quality profile 242. In contrast to device quality profile 242, which can store empirical profiling data, predictive model 244 predicts the quality delta for combinations of streaming attributes including bitrate, resolution, quantization parameter, perceptual quality associated with the encoded media content, content features, and device settings. Predictive model 244 is therefore more flexible than a dataset comprising explicit profiling entries, while providing equivalent device-specific perceptual quality adjustment information for use by ABR engine 332 on endpoint device 115. Accordingly, predictive model 244 is derived from profiling data that determines device quality profile 242.

In some embodiments, predictive model 244 constitutes a machine learning model trained using multiple device quality profiles 242. Example implementations could include regression models configured to estimate quality delta. Predictive model 244 can therefore learn relationships between the streaming parameters, such as resolution, bitrate, quantization parameter values used during encoding, and the quality delta observed in post-processed frames generated by endpoint device 115.

The predicted quality delta output by predictive model 244 can be applied to perceptual quality values associated with the encoded media content to determine adjusted perceptual quality values associated with post-processed media content after device-side post-processing. Such adjusted perceptual quality values enable streaming application 119 on endpoint device 115 to account for device-side post-processing when selecting bitrate and resolution representations for streaming media content.

Notably, device quality profile 242 represents device-specific knowledge empirically generated from profiling, while predictive model 244 represents a predictive mechanism generated from the profiling knowledge. ABR engine 332 can utilize device quality profile 242, predictive model 244, or a combination thereof depending on the embodiment.

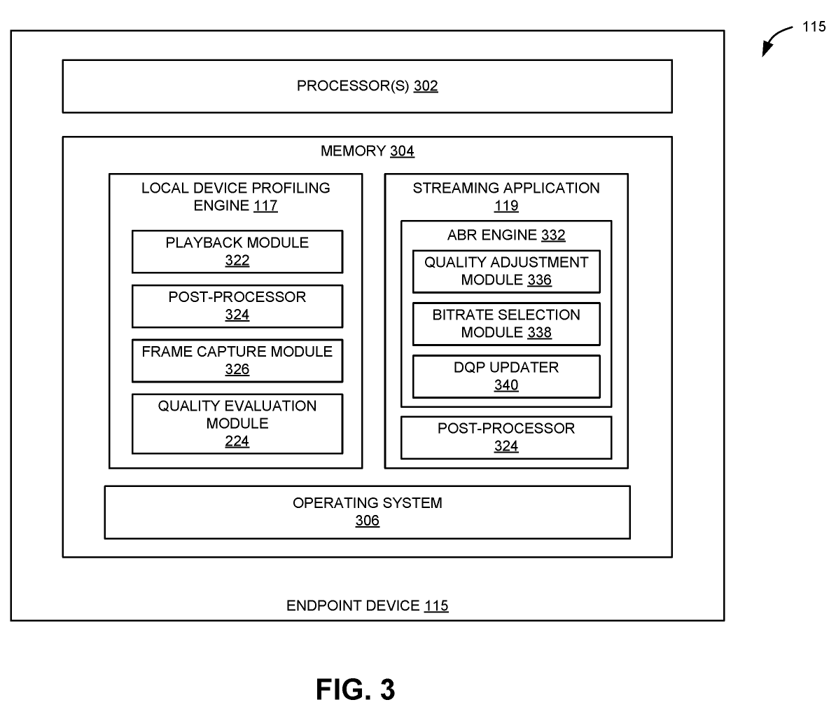

FIG. 3 is a more detailed conceptual illustration of endpoint device 115 of FIG. 1, according to various embodiments. FIG. 3 includes, without limitation, processor(s) 302 and a memory 304. Memory 304 includes, without limitation, local device profiling engine 117 and streaming application 119. Local device profiling engine 117 includes, without limitation, playback module 322, a post-processor 324, frame capture module 326, and quality evaluation module 224. Streaming application 119 includes, without limitation, adaptive bitrate (ABR) engine 332 and post-processor 324. ABR engine 332 includes, without limitation, quality adjustment module 336, bitrate selection module 338, and DQP updater 340.

Processor(s) 302 can be any instruction execution system, apparatus, or device capable of executing instructions. For example, processor(s) 302 can include a central processing unit (CPU), a graphics processing unit (GPU), one or more system on chips (SoCs), a controller, a microcontroller, a state machine, or any combination thereof. Notably, different SoC implementations in processor(s) 302 can implement video rendering operations differently. For example, different processor(s) 302 can employ different decoding implementations, different upscaling techniques including AI super-resolution, and different post-processing operations. As a result, media content processed on processor(s) 302 can result in a different perceptual quality than decoding of encoded media content transmitted to endpoint device 115.

Memory 304 stores content for use by processor(s) 302. Memory 304 can be one or more readily available memories, such as random access memory (RAM), read-only memory (ROM), a floppy disk, a hard disk, or any other form of digital storage, local or remote. In some embodiments, storage (not shown) can supplement memory 304. Memory 304 can include any number and type of external memories that are accessible to processor(s) 302. For example, and without limitation, memory 304 can include a Secure Digital Card, an external flash memory, a portable compact disc read-only memory (CD-ROM), an optical storage device, a magnetic storage device, or any suitable combination of the foregoing.

Operating system 306 can be any feasible operating system. For example, operating system 306 could include Linux®, Microsoft Windows®, and/or Android™.

ABR engine 332 executes adaptive bitrate selection for streaming media content. Adaptive bitrate selection is a process in which streaming application 119 uses ABR engine 332 and dynamically selects among multiple encoded representations of the media content that differ in bitrate and resolution. The encoded representations can correspond to an encoded representation ladder generated during media encoding. ABR engine 332 evaluates the encoded representations and determines which representation should be requested and rendered on endpoint device 115 so that media content can be streamed efficiently while maintaining acceptable perceptual quality.

ABR engine 332 receives device quality profile 242 as an input during streaming operations. ABR engine 332 evaluates available encoded representations based on device quality profile 242 and selects bitrate and resolution combinations for playback.

In some embodiments, ABR engine 332 uses device quality profile 242 to determine whether switching to higher bitrate representations is beneficial. For example, ABR engine 332 could determine that device quality profile 242 indicates that perceptual quality associated with endpoint device 115 approaches a quality ceiling near a particular bitrate. When device quality profile 242 indicates that perceptual quality saturates near the particular bitrate, ABR engine 332 can avoid selecting higher bitrate representations that would not significantly improve perceptual quality. Advantageously, by avoiding unnecessary transitions to higher bitrate representations, ABR engine 332 can reduce network bandwidth consumption and reduce load on content delivery network infrastructure while maintaining perceptual quality of post-processed media content.

In some embodiments, ABR engine 332 utilizes a rate-distortion curve derived from perceptual quality values to guide adaptive bitrate selection decisions. The rate-distortion curve is determined using the perceptual quality values. In some embodiments, the rate-distortion curve is determined using perceptual quality values in the form of the quality map. In some embodiments, the rate-distortion curve is post-processing aware such that the post-processing aware rate-distortion curve (e.g., associated with the post-processed video frames) is shifted upward relative to a rate-distortion curve derived from perceptual quality values associated with encoded video frames. Therefore, the post-processing aware rate-distortion curve reflects improved perceptual quality resulting from device-side post-processing. ABR engine 332 can construct or evaluate a convex hull over the rate-distortion curve, where the convex hull determines switching points between bitrate and resolution representations based on perceptual quality. Such switching points indicate when transitioning to a higher resolution provides a greater perceptual quality benefit than increasing bitrate within a current resolution. In some embodiments, ABR engine 332 identifies a saturation point along the rate-distortion curve at which increases in bitrate yield negligible improvements in perceptual quality and accordingly avoids selecting higher bitrate representations beyond the saturation point to reduce bandwidth usage while maintaining perceptual quality.

Playback module 322 enables playback of the media content on endpoint device 115. In some embodiments, playback module 322 coordinates requests, retrieval, and display of media content during streaming operations. For example, playback module 322 can receive encoded media content obtained by streaming application 119 and manage decoding, buffering, and rendering operations required to present the media content on endpoint device 115.

Playback module 322 operates in conjunction with post-processor 324 to enable device-side post-processing operations during playback of streaming media content. In some embodiments, playback module 322 can provide decoded video frames to post-processor 324 so that post-processor 324 can execute device-side enhancement operations before the decoded video frames are rendered on endpoint device 115. In some embodiments, playback module 322 can fully render the decoded video frames and then pass the decoded video frames to post-processor 324.

Post-processor 324 executes device-side post-processing operations during playback of streaming media content. Post-processor 324 receives decoded video frames from playback module 322 and executes enhancement operations prior to display on endpoint device 115. Such device-side post-processing operations improve perceptual quality of post-processed media content based on device capabilities of endpoint device 115 and device configuration of endpoint device 115. For example, post-processor 324 could apply operations such as AI super-resolution (AISR) processing, spatial upscaling, sharpening, noise reduction, and/or edge enhancement to improve visual clarity of the rendered frames.

In some embodiments, post-processor 324 can apply post-processing operations with different processing strengths depending on device configuration of endpoint device 115. For example, endpoint device 115 could allow device picture quality settings to specify strong, medium, or mild processing strengths for post-processing operations. The selected processing strength can affect how aggressively post-processor 324 modifies the video frames before display. As a result, perceptual quality of the video frames can vary depending on the device configuration and the processing strength used.

Frame capture module 326 captures the post-processed video frames after playback module 322 and post-processor 324 process the media content. In particular, frame capture module 326 captures video frames that have already been decoded by playback module 322 and enhanced by post-processor 324.

In some embodiments, frame capture module 326 is implemented on endpoint device 115 and captures frames directly after post-processing operations have been applied. In other embodiments, frame capture module 326 can correspond to a companion capture tool configured to obtain rendered post-processed video frames from endpoint device 115.

Quality adjustment module 336 calculates quality delta associated with post-processed media content compared with encoded media content. In conventional adaptive streaming systems, perceptual quality values correspond to perceptual quality values measured from the encoded video frames prior to device-side post-processing. However, because endpoint device 115 can apply device-side post-processing using post-processor 324, perceptual quality experienced by a viewer can differ from the perceptual quality associated with the encoded media content. Quality adjustment module 336 therefore calculates the perceptual quality to be consumed by ABR engine 332 so that adaptive bitrate selection decisions account for quality delta introduced by device-side post-processing.

During deployment, quality adjustment module 336 uses device quality profile 242 and/or predictive model 244 to estimate quality delta between the encoded media content and the processed media content during playback. Quality adjustment module 336 can receive device quality profile 242 and the streaming attributes associated with the encoded media content and endpoint device 115. Quality adjustment module 336 passes the inputs to predictive model 244. Quality adjustment module 336 then takes an output of predictive model 244 as the quality delta.

Quality adjustment module 336 then adds the quality delta to perceptual quality values associated with the encoded media content to determine adjusted perceptual quality values corresponding to rendered post-processed media content after device-side post-processing. The adjusted perceptual quality values represent device-adjusted perceptual quality estimates that ABR engine 332 can use when selecting streaming representations.

The adjusted perceptual quality values generated by quality adjustment module 336 enable ABR engine 332 to evaluate encoded representations based on the perceptual quality expected after device-side post-processing rather than only perceptual quality values associated with the encoded media content. By adjusting perceptual quality values in such a manner, quality adjustment module 336 allows ABR engine 332 to execute adaptive bitrate selection that more accurately reflects perceptual quality experienced on endpoint device 115. Additional details of the operations executed by quality adjustment module 336 are described in greater detail in conjunction with FIG. 5.

Bitrate selection module 338 selects a bitrate and resolution for streaming media content based on the adjusted perceptual quality values and adaptive streaming criteria. Bitrate selection module 338 evaluates available encoded representations that differ in bitrate and resolution and determines which representation should be requested for playback on endpoint device 115. The selected representation can correspond to an encoded representation available from content server 110 or a content delivery network and can be requested by streaming application 119 during playback.

In some embodiments, bitrate selection module 338 operates using the adjusted perceptual quality values generated by quality adjustment module 336. Bitrate selection module 338 receives the adjusted perceptual quality values generated by quality adjustment module 336. Bitrate selection module 338 evaluates the encoded representations using the adjusted perceptual quality values and determines an encoded representation that satisfies adaptive streaming criteria associated with ABR engine 332. For example, bitrate selection module 338 could determine a representation that provides efficient perceptual quality relative to bitrate usage while maintaining acceptable perceptual quality for playback on endpoint device 115.

Bitrate selection module 338 then initiates requests for encoded media content corresponding to the selected bitrate and resolution so that playback module 322 can render the media content on endpoint device 115.

DQP updater 340 updates device quality profile 242 and/or predictive model 244 when device-side post-processing behavior changes over time. Device-side post-processing behavior executed by post-processor 324 can change due to firmware updates, changes to models (e.g., AI models) implemented by endpoint device 115, or modifications to device picture quality settings that control post-processing strength. Because such changes can alter perceptual quality of media content rendered by endpoint device 115, DQP updater 340 periodically refreshes device quality profile 242 and predictive model 244 so that the perceptual quality values used by ABR engine 332 remain accurate.

In some embodiments, DQP updater 340 executes device-side verification tests using a subset of original video frames when endpoint device 115 is idle. The subset of original video frames can correspond to previously evaluated test content used during device profiling operations. Endpoint device 115 can render the selected video frames using playback module 322 and post-processor 324 and capture rendered post-processed video frames using frame capture module 326. The captured rendered post-processed video frames can then be evaluated to determine the adjusted perceptual quality values associated with a current device configuration. Based on the adjusted perceptual quality values, DQP updater 340 can update or patch predictive model 244 used by ABR engine 332 during adaptive streaming operations.

Through such an adaptive updating process, DQP updater 340 enables endpoint device 115 to maintain an accurate representation of device-side post-processing performance over time. As device quality profile 242 and predictive model 244 are updated, ABR engine 332 can continue to execute adaptive bitrate selection using perceptual quality estimates that reflect current device behavior, allowing streaming application 119 to maintain efficient network usage while preserving perceptual quality of rendered media content.

In some embodiments, DQP updater 340 can additionally monitor device configuration information associated with endpoint device 115 to determine whether device quality profile 242 should be updated. In response to such changes, DQP updater 340 requests media content from control server 120 or executes local evaluation using stored media content. Results (e.g., quality delta) obtained from the evaluations can be used to update device quality profile 242 and update predictive model 244 so that perceptual quality estimates used by ABR engine 332 reflect the current post-processing behavior of endpoint device 115.

In some embodiments, DQP updater 340 can refresh device quality profile 242 and predictive model 244 to accommodate evolving evaluation criteria and application requirements. For example, perceptual quality evaluation criteria can change over time as new metrics, encoding techniques, or device-side post-processing capabilities are introduced. Additionally, different streaming applications, such as video streaming and cloud gaming, require different predictive models 244 due to differences in latency sensitivity, motion characteristics, and/or rendering requirements. Accordingly, DQP updater 340 can regularly update predictive model 244 and device quality profile 242 to reflect revised evaluation criteria or application-specific requirements. In some embodiments, DQP updater 340 can execute when a user switches between different streaming applications 119 (e.g., from video streaming to cloud gaming). ABR engine 332 can then update adaptive bitrate selection logic based on the updated predictive model 244 and device quality profile 242 so that bitrate selection decisions remain aligned with a particular streaming application.

FIG. 4A illustrates a profiling workflow 400 for generation of device quality profiles 242 and predictive model 244 of FIG. 2, according to various embodiments. Profiling workflow 400 includes, without limitation, device profiling manager 122 and local device profiling engine 117. Device profiling manager 122 includes, without limitation, test distribution module 222, quality evaluation module 224, DQP generation module 226, and model training module 228. Local device profiling engine 117 includes, without limitation, playback module 322, post-processor 324, and frame capture module 326. Test distribution module 222 receives original video frames 402 and encoded video frames 404. Quality evaluation module 224 generates encoded media VMAF values 406. Frame capture module 326 generates post-processed video frames 408. Quality evaluation module 224 generates post-processed media VMAF values 410 and a quality delta 412. DQP generation module 226 generates device quality profile 242 and a post-processing aware rate-distortion curve 414. Model training module 228 generates predictive model 244.

Notably, profiling workflow 400 can be executed for endpoint device 115 or for a class of endpoint devices 115 having similar device-side processing characteristics. Profiling workflow 400 can correspond to a controlled test used to evaluate quality delta introduced by device-side post-processing. In some embodiments, profiling workflow 400 can be conducted during device certification procedures, at a manufacturing facility during device production, upon initial activation of endpoint device 115, or periodically during operation of endpoint device 115 while streaming application 119 executes normal streaming operations.

In some embodiments, endpoint device 115 initiates an adaptive retest of profiling workflow 400 when device configuration changes occur (e.g., via DQP updater 340). For example, endpoint device 115 can detect changes in device picture quality settings or other device configuration parameters via DQP updater 340 that affect post-processing behavior executed by post-processor 324. In response to detecting such changes, endpoint device 115 initiates a retest of endpoint device 115 using profiling workflow 400. Results obtained during the retest can be used to update device quality profile 242 and refine predictive model 244. ABR engine 332 can then adjust adaptive bitrate selection behavior based on updated device quality profile 242 so that endpoint device 115 continues to receive media content that provides high perceptual quality while using network bandwidth efficiently.

In some embodiments, profiling workflow 400 is applied to other media content beyond video streaming. For example, profiling workflow 400 could be applied to audio streaming applications in which endpoint device 115 executes device-side audio processing during playback. In such embodiments, device profiling manager 122 can distribute encoded audio samples to endpoint device 115 and evaluate quality delta associated with device-side audio processing. Quality evaluation module 224 can measure an encoded audio quality metric associated with encoded audio and can measure a post-processed audio quality metric associated with audio output generated after device-side audio processing. Quality evaluation module 224 can determine an audio quality delta representing differences in perceptual quality between the encoded audio and the post-processed audio after device-side processing. Based on the audio quality delta, device profiling manager 122 can generate an audio-specific post-processing aware rate-distortion curve for use by ABR engine 332 during adaptive streaming of audio media content.

In some embodiments, endpoint device 115 can execute a modified version of profiling workflow 400 as self-testing to maintain accuracy of predictive model 244 and device quality profile 242. For example, endpoint device 115 can execute a self-test procedure using a subset of encoded video frames 404, which can be stored locally or received from control server 120. During the self-test, playback module 322 and post-processor 324 render encoded video frames 404, and frame capture module 326 captures post-processed video frames 408 for evaluation. Quality evaluation module 224 then computes perceptual quality values and determines whether measured perceptual quality deviates from values predicted by predictive model 244. When such deviation is detected, DQP updater 340 can recalibrate predictive model 244 or update device quality profile 242, for example by updating partition parameters or other model components. Such a local update process enables endpoint device 115 to continuously adapt predictive model 244 and device quality profile 242 after deployment. The continuous adaptation maintains accurate perceptual quality estimation despite changes in device firmware, post-processing behavior, or device configuration.

Operation of profiling workflow 400 is as follows. Test distribution module 222 organizes original video frames 402 according to a test scenario to be executed. Original video frames 402 correspond to video frames of media content to be used for device profiling. In some embodiments, original video frames 402 represent video frames covering various content types so that device profiling manager 122 can evaluate device-side processing behavior across different visual characteristics. For example, original video frames 402 can include scenes containing high motion, animation content, or low-light environments. Original video frames 402 are then encoded into multiple encoded representations as encoded video frames 404.

Encoded video frames 404 are encoded versions of original video frames 402. Encoded video frames 404 therefore have different resolution, bitrate, and quantization parameter settings so that perceptual quality behavior can be evaluated across multiple encoding conditions. Encoded video frames 404 can also represent multiple content categories, such as high-motion scenes, animation content, and low-light scenes, so that profiling workflow 400 evaluates device-side post-processing behavior across different visual characteristics. Encoded video frames 404 can be generated at multiple resolution, bitrate, and quantization parameter settings so that device profiling manager 122 can evaluate perceptual quality across multiple encoded representations.

In some embodiments, test distribution module 222 obtains encoded video frames 404 from a media preparation pipeline or content repository (e.g., content server 110) containing previously encoded media content. In other embodiments, test distribution module 222 can coordinate generation of encoded video frames 404 by providing original video frames 402 to an encoder that generates encoded video frames 404 at multiple resolution, bitrate, and quantization parameter settings. After organizing encoded video frames 404, test distribution module 222 transmits encoded video frames 404 to local device profiling engine 117 executing on endpoint device 115.

Quality evaluation module 224 generates encoded media VMAF values 406. In some embodiments, quality evaluation module 224 receives original video frames 402 and encoded video frames 404 and evaluates perceptual quality of encoded video frames 404 relative to original video frames 402 to generate encoded media VMAF values 406.

In some embodiments, quality evaluation module 224 measures perceptual quality using Video Multi-Method Assessment Fusion (VMAF), Video Multi-Method Assessment Fusion – No Enhancement Gain (VMAF-NEG), Peak Signal-to-Noise Ratio (PSNR), and/or Structural Similarity Index Measure (SSIM). Such measured perceptual quality values are represented by encoded media VMAF values 406. Quality evaluation module 224 can generate encoded media VMAF values 406 for each encoded representation corresponding to a particular resolution and bitrate combination of encoded video frames 404.

Encoded media VMAF values 406 represent perceptual quality values associated with encoded video frames 404 prior to device-side post-processing. In some embodiments, encoded media VMAF values 406 are stored as metadata in a quality map that associates each bitrate and resolution representation with a corresponding perceptual quality value.

In conventional adaptive streaming techniques, perceptual quality values (e.g., encoded media VMAF values 406) are used by ABR engine 332 to evaluate tradeoffs between bitrate and visual quality when selecting an encoded representation for playback. For example, in conventional adaptive streaming techniques, ABR engine 332 evaluates multiple bitrate and resolution combinations and selects a representation that provides an acceptable balance between perceptual quality and network bandwidth consumption. Advantageously, in profiling workflow 400, encoded media VMAF values 406 correspond to baseline perceptual quality values that are later compared with perceptual quality associated with post-processed video frames 408 (e.g., post-processed media VMAF values 410) generated after device-side post-processing.

In some embodiments, generation of encoded media VMAF values 406 can occur before encoded video frames 404 are transmitted to local device profiling engine 117, during transmission of encoded video frames 404, or after encoded video frames 404 have been rendered by endpoint device 115.

In some embodiments, encoded media VMAF values 406 are stored in a quality map that includes multiple encoded media VMAF values 406 associated with corresponding representation parameters, including bitrate and resolution of encoded video frames 404. The quality map can be generated by quality evaluation module 224 by computing encoded media VMAF values 406 for each encoded representation relative to original video frames 402. Each entry in the quality map can correspond to a specific bitrate and resolution combination and associated encoded media VMAF values 406. The quality map can be stored as metadata accessible during streaming operations and consumed by ABR engine 332 to evaluate candidate representations.

Local device profiling engine 117 receives encoded video frames 404. Playback module 322 decodes encoded video frames 404 and initiates rendering operations. Post-processor 324 receives decoded frames generated by playback module 322 and executes device-side post-processing operations on decoded frames. Frame capture module 326 captures frames generated after execution of playback module 322 and post-processor 324. Frames captured by frame capture module 326 correspond to post-processed video frames 408.

Post-processed video frames 408 represent rendered video output generated by endpoint device 115 after device-side post-processing operations are applied. As a result, post-processed video frames 408 reflect a perceptual quality experienced on endpoint device 115 after post-processing behavior of post-processor 324.

In some embodiments, post-processed video frames 408 are transmitted from endpoint device 115 to control server 120 for computation of post-processed media VMAF values 410 by quality evaluation module 224. In other embodiments, when quality evaluation module 224 is included in endpoint device 115, or when elements of quality evaluation module 224 are included in endpoint device 115, post-processed video frames 408 remain on endpoint device 115, and post-processed media VMAF values 410 are generated locally using quality evaluation module 224 on endpoint device 115. In some embodiments, a companion tool associated with endpoint device 115 executes quality evaluation module 224 to generate post-processed media VMAF values 410. In such embodiments, post-processed media VMAF values 410 are transmitted to control server 120 after generation.

Quality evaluation module 224 on control server 120 then generates quality delta 412 using a difference between encoded media VMAF values 406 and post-processed media VMAF values 410. Quality evaluation module 224 subtracts encoded media VMAF values 406 from post-processed media VMAF values 410 for each encoded representation corresponding to a particular resolution and bitrate combination.

Quality delta 412 corresponds to perceptual quality differences introduced by device-side post-processing executed by post-processor 324. By determining quality delta 412 across multiple resolution and bitrate combinations, device profiling manager 122 can characterize how device-side post-processing improves perceptual quality of post-processed media content for each encoded representation.

In some embodiments, device profiling manager 122 analyzes quality delta 412 and associated post-processing behavior of endpoint device 115 to determine whether endpoint device 115 satisfies predefined performance thresholds associated with acceptable device-side post-processing behavior. If quality delta 412 does not satisfy the predefined performance thresholds, device profiling manager 122 can identify endpoint device 115 as exhibiting anomalous post-processing behavior prior to deployment. Endpoint devices 115 that do not satisfy the predefined performance thresholds are therefore excluded from adaptive bitrate optimization based on the common device quality profile 242 so that ABR engine 332 relies on device quality profiles 242 associated only with endpoint devices 115 that satisfy the predetermined performance thresholds.

Using one or more quality delta 412, DQP generation module 226 generates device quality profile 242. In some embodiments, DQP generation module 226 organizes quality delta 412 into a dataset associated with endpoint device 115 under different test conditions. Each entry in device quality profile 242 can correspond to a particular test condition evaluated during profiling workflow 400.

In some embodiments, device quality profile 242 generated by DQP generation module 226 includes information such as an identifier associated with endpoint device 115, a firmware version associated with endpoint device 115, and a device-side post-processing strength setting applied by post-processor 324. Device quality profile 242 can further include streaming attributes associated with the encoded representation evaluated during profiling workflow 400, including resolution, bitrate, and content characteristics associated with encoded video frames 404. Device quality profile 242 can also include perceptual quality values, including encoded media VMAF values 406 associated with encoded video frames 404, post-processed media VMAF values 410 associated with post-processed video frames 408, and quality delta 412.

Device quality profile 242 represents a dataset of empirical profiling data describing perceptual quality behavior observed during execution of profiling workflow 400 of endpoint device 115. Empirical profiling data refers to measured quality delta 412 obtained through execution of profiling workflow 400 rather than predicted or estimated values.

In some embodiments, DQP generation module 226 generates device-specific partitions corresponding to groups of endpoint devices 115 that share similar device configurations, firmware versions, or post-processing behavior implemented by post-processor 324. Such partitions allow device profiling manager 122 to generate device quality profile 242 information associated with specific device groups.

In some embodiments, DQP generation module 226 generates post-processing aware rate-distortion curve 414 based on information used to generate device quality profile 242, or information stored in device quality profile 242. In some embodiments, post-processing aware rate-distortion curve 414 is generated during streaming operations by ABR engine 332 based on device quality profile 242 transmitted to endpoint device 115.

Post-processing aware rate-distortion curve 414 represents a relationship between bitrate and perceptual quality associated with rendered media content generated by endpoint device 115 after execution of post-processor 324. For example, the horizontal axis of post-processing aware rate-distortion curve 414 could represent bitrate associated with encoded video frames 404, while the vertical axis could represent perceptual quality values such as post-processed media VMAF values 410.

Notably, in conventional streaming techniques, a rate-distortion curve generated with encoded media VMAF values 406 gradually approaches a plateau as bitrate increases, which reflects diminishing improvements in perceptual quality as additional bits are allocated. Advantageously, post-processing aware rate-distortion curve 414 shifts upward at lower bitrate values because post-processor 324 can enhance lower-resolution or more heavily compressed content rendered on endpoint device 115. As a result, perceptual quality associated with post-processed video frames 408 can be higher than perceptual quality associated with encoded video frames 404 at a same bitrate value.

Post-processing aware rate-distortion curve 414 can eventually flatten as bitrate increases, which indicates a saturation point associated with endpoint device 115. The saturation point represents a bitrate at which additional increases in bitrate generate minimal additional increases to perceptual quality after device-side post-processing executed by post-processor 324. In some embodiments, DQP generation module 226 can determine the saturation point by analyzing changes in perceptual quality values across successive bitrate values and identifying a bitrate at which increases in perceptual quality fall below a predetermined threshold. The identified saturation point can be stored in device quality profile 242 and later used by ABR engine 332 to avoid selecting encoded representations with a bitrate that exceeds the saturation point when the bitrate would not significantly improve perceptual quality on endpoint device 115.

Model training module 228 receives device quality profile 242 and quality delta 412 generated during profiling workflow 400 and trains predictive model 244. In some embodiments, additional inputs to model training module 228 include device characteristics associated with endpoint device 115, content features associated with encoded video frames 404, bitrate, resolution, and a post-processing state associated with post-processor 324. In some embodiments, the inputs further include quantization parameter values used during encoding, encoded media VMAF values 406, and derived attributes associated with the results. In some embodiments, the inputs further include device picture quality settings associated with endpoint device 115. Device picture quality settings can include settings associated with brightness, contrast, post-processing strength, or other device-side processing behavior executed by post-processor 324. In some embodiments, derived attributes are also used during training. For example, the derived attributes can correspond to a distortion index determined from quantization parameter values used during encoding and resolution. In some embodiments, such additional inputs are stored and passed into model training module 228 using device quality profile 242.

Model training module 228 uses quality delta 412 as a target value during training so that predictive model 244 learns relationships between inputs and quality delta 412 introduced by device-side post-processing.

In some embodiments, model training module 228 trains predictive model 244 using a large profiling dataset based on multiple device quality profiles 242 and quality delta 412. For example, the profiling dataset can include thousands of device quality profiles 242 and quality delta 412 collected across multiple encoded video frames 404, multiple endpoint devices 115, and multiple device configurations. Model training module 228 generates trained parameters for predictive model 244 so that predictive model 244 estimates quality delta 412 for a given combination of streaming attributes such as device characteristics, content features, bitrate, resolution, and post-processing state. In some embodiments, predictive model 244 can correspond to a regression model, a partition model, or another predictive function configured to estimate quality delta 412.

Advantageously, profiling workflow 400 can be used to detect degradation in post-processing performance of endpoint device 115 over time. In some embodiments, endpoint device 115 can periodically input encoded media content (e.g., encoded video frames 404) and execute evaluation using predictive model 244 and device quality profile 242.

Advantageously, profiling workflow 400 does not depend on how post-processing operations are implemented within endpoint device 115. For example, post-processor 324 can perform device-side post-processing using algorithms, hardware acceleration, or artificial intelligence techniques that are not accessible or known to control server 120. Profiling workflow 400 empirically measures post-processed video frames 408 rather than modeling internal behavior of post-processor 324. By relying on measured output instead of internal implementation details, profiling workflow 400 characterizes perceptual quality across different endpoint device 115 implementations without requiring knowledge of specific post-processing techniques employed.

FIG. 4B illustrates example rate-distortion curves 460, according to various embodiments. Rate-distortion curves 460 include, without limitation, encoded rate-distortion curves 462, post-processing aware rate-distortion curve 464, convex hull switching points 466, saturation points 468, and quality ceiling 470.

Encoded rate-distortion curve 462 represents an encoded rate-distortion relationship corresponding to video content prior to device-side post-processing. A horizontal axis represents bitrate, and a vertical axis represents perceptual quality values using a metric such as VMAF. As bitrate increases, perceptual quality improves but gradually approaches a plateau where additional bitrate yields diminishing perceptual improvement.

Post-processing aware rate-distortion curve 464 represents a perceptual quality of video content after device-side post-processing operations are applied. Post-processing operations such as artificial intelligence super resolution, denoise processing, and edge enhancement improve perceptual quality relative to a baseline associated with encoded video frames. As a result, post-processing aware rate-distortion curve 464 is shifted upward compared to encoded rate-distortion curve 462, which indicates that higher perceptual quality can be achieved at lower bitrates when device-side post-processing is utilized.

Convex hull switching points 466 represent a set of optimal representation transition points across multiple resolutions (e.g., 540p, 720p, and 1080p). Convex hull switching points 466 determine where switching from one resolution representation to another provides a meaningful quality delta relative to bandwidth cost. Convex hull switching points 466A correspond to a convex hull associated with encoded media content (e.g., encoded video frames 404) before post-processing. Convex hull switching points 466B correspond to a convex hull associated with processed media content (e.g., post-processed video frames 408). FIG. 4B illustrates that post-processing shifts convex hull switching points 466B upward compared to convex hull switching points 466A, which changes optimal switching points between resolutions and therefore affects adaptive bitrate streaming decisions.

Saturation points 468 indicate a bitrate for a given resolution at which increases in bitrate result in diminishing improvements in perceptual quality. FIG. 4B illustrates that device-side post-processing moves saturation points 468 to lower bitrates, which indicates that equivalent perceived quality can be achieved with less bandwidth.

Quality ceiling 470 corresponds to a horizontal line that indicates a maximum perceptual quality achievable for a given resolution or device. Quality ceiling 470 therefore acts as an upper bound of perceptual quality. Because device-side post-processing improves perceptual quality at lower bitrates, post-processing aware rate-distortion curve 464 reaches quality ceiling 470 earlier than encoded rate-distortion curve 462, which enables adaptive bitrate algorithms to select lower bitrate streams while maintaining comparable perceived visual quality.

FIG. 5 illustrates a deployment workflow 500 for consumption of device quality profile 242 and predictive model 244 during streaming, according to some embodiments. Deployment workflow 500 includes, without limitation, deployment module 124 and streaming application 119. Streaming application 119 includes, without limitation, ABR engine 332. ABR engine 332 includes, without limitation, quality adjustment module 336, bitrate selection module 338, playback module 322, and post-processor 324. Deployment module 124 transmits device quality profile 242, predictive model 244, encoded media VMAF values 406, and streaming attributes 502 to streaming application 119.

In some embodiments, quality adjustment module 336 inputs device quality profile 242, encoded media VMAF values 406, and streaming attributes 502 into predictive model 244 to generate quality delta 412. In some embodiments, device quality profile 242 is used as a lookup table with streaming attributes 502 and encoded media VMAF values 406 as input and quality delta 412 as output.

Bitrate selection module 338 receives quality delta 412 and selects bitrate and resolution 504. Bitrate and resolution 504 are used by ABR engine 332 to select encoded video frames 404. Playback module 322 streams selected encoded video frames 404, and post-processor 324 post-processes selected encoded video frames 404.

Streaming attributes 502 correspond to one or more attributes associated with encoded representations and device configuration when endpoint device 115 executes streaming playback. In some embodiments, streaming attributes 502 include representation parameters, device picture quality settings, content characteristics, and device quality profile parameters used by predictive model 244. Such attributes can be obtained by streaming application 119 during streaming playback and provided to quality adjustment module 336 and ABR engine 332. In some embodiments, streaming attributes 502 further include representation parameters associated with encoded representations available for streaming. The representation parameters include bitrate, resolution, and quantization parameter values used during encoding. The representation parameters can be obtained, for example, from a streaming manifest or representation ladder describing available encoded representations. Streaming application 119 can retrieve the representation parameters during streaming playback.

In some embodiments, streaming attributes 502 further include device picture quality settings associated with endpoint device 115. Device picture quality settings can include device configuration parameters that influence device-side processing executed by post-processor 324. For example, device picture quality settings can include brightness settings, contrast settings, artificial intelligence super resolution (AISR) strength values, denoise strength values, and/or other device processing configuration parameters that affect rendered media content on endpoint device 115. Streaming attributes 502 can also include content characteristics associated with encoded video frames 404. Content characteristics can include content features derived from the encoded media content (e.g., encoded video frames 404) or attributes derived from encoding parameters. For example, content characteristics can include a distortion index derived from quantization parameter values used during encoding and resolution associated with encoded video frames 404.

Operation of deployment workflow 500 is as follows. Deployment module 124 transmits encoded media content (e.g., encoded video frames 404) to endpoint device 115. In some embodiments, control server 120 coordinates delivery of the encoded media content through content server 110 or a content delivery network so that streaming application 119 on endpoint device 115 can retrieve the encoded media content. The encoded media content is available as multiple encoded representations corresponding to different resolution and bitrate combinations determined by a representation ladder.

Deployment module 124 transmits encoded media VMAF values 406 associated with candidate bitrates and resolutions of the encoded media content. Deployment module 124 further transmits predictive model 244 and/or device quality profile 242. Deployment module 124 can also transmit objects included in streaming attributes 502, including streaming attributes 502 associated with encoded video frames 404.

In some embodiments, deployment module 124 transmits predictive model 244, device quality profile 242, encoded media VMAF values 406, and streaming attributes 502 during onboarding or update operations associated with endpoint device 115. In some embodiments, encoded media VMAF values 406 can be transmitted in the form of a quality map. For example, encoded media VMAF values 406 can be transmitted during installation of streaming application 119, during endpoint device 115 registration, periodically during endpoint device 115 operation, or in response to changes in firmware that affect device-side post-processing behavior.

ABR engine 332 executes adaptive bitrate selection during streaming playback executed by streaming application 119 on endpoint device 115. During deployment workflow 500, ABR engine 332 evaluates candidate representations and selects a representation for playback based on perceptual quality estimates and adaptive streaming criteria.

ABR engine 332 obtains encoded media VMAF values 406 associated with candidate representations of encoded video frames 404, in some embodiments, in the form of a quality map. ABR engine 332 further obtains device quality profile 242 and, in some embodiments, predictive model 244.

ABR engine 332 determines inputs used for determining perceptual quality during streaming playback. For each candidate representation, ABR engine 332 determines device characteristics associated with endpoint device 115, including identifiers associated with device quality profile 242. ABR engine 332 can also determine a post-processing state associated with post-processor 324, including whether artificial intelligence super resolution is enabled and a corresponding strength level. In some embodiments, ABR engine 332 can additionally determine content features associated with encoded video frames 404 or derived from streaming attributes 502, such as content classification information or heuristic distortion indicators, so that predictive model 244 can estimate perceptual quality associated with rendered video frames.

Quality adjustment module 336 receives encoded video frames 404 and streaming attributes 502, together with encoded media VMAF values 406. In some embodiments, quality adjustment module 336 provides the inputs to predictive model 244. In some embodiments, quality adjustment module 336 accesses encoded media VMAF values 406 from the quality map.

In some embodiments, quality adjustment module 336 determines quality delta 412 using device quality profile 242 by retrieving quality delta 412 corresponding to candidate representations from device quality profile 242. In some embodiments, quality adjustment module 336 extracts information from device quality profile 242 to generate a post-processing aware rate-distortion curve and determines a bitrate and resolution for playback in streaming operations based on the post-processing aware rate distortion curve. In some embodiments, quality adjustment module 336 utilizes saturation points or a quality ceiling determined by device quality profile 242 to determine quality delta 412 or to directly determine selection of bitrate and resolution 504. In some embodiments, quality adjustment module 336 utilizes reduced profile parameters stored in device quality profile 242 to determine quality delta 412 for candidate representations based on streaming attributes 502.

In some embodiments, quality adjustment module 336 uses predictive model 244 to process streaming attributes 502 and encoded media VMAF values 406 to estimate quality delta 412 associated with candidate representations for endpoint device 115. In some embodiments, predictive model 244 generates one or more quality delta 412 corresponding to each candidate representation.

Quality adjustment module 336 then generates the adjusted perceptual quality values associated with each candidate representation. For each candidate representation, quality adjustment module 336 combines encoded media VMAF values 406 with predicted quality delta 412 to compute the adjusted quality values after device-side post-processing. In some embodiments, the adjusted perceptual quality values are in the form of adjusted VMAF values. The adjusted perceptual quality values represent a device-adjusted perceptual quality corresponding to encoded video frames 404 and reflect the perceptual quality expected after execution of post-processor 324. Quality adjustment module 336 provides the adjusted perceptual quality values to bitrate selection module 338.

In some embodiments, the adjusted perceptual quality values collectively determine a post-processing aware rate-distortion curve that reflects perceptual quality after execution of post-processor 324 on endpoint device 115. ABR engine 332 uses the post-processing aware rate-distortion curve via bitrate selection module 338 during streaming playback to determine saturation points where additional increases in bitrate yield negligible changes in perceptual quality and to execute switching decisions between candidate representations of bitrate and resolution.

Bitrate selection module 338 receives the adjusted perceptual quality values (e.g., the VMAF values). Using the adjusted perceptual quality values, bitrate selection module 338 selects a bitrate and resolution 504 that achieves a target perceptual quality while reducing unnecessary bandwidth usage during streaming playback executed by streaming application 119.

In some embodiments, bitrate selection module 338 updates rate-distortion evaluation logic used by ABR engine 332 based on the adjusted perceptual quality values. The adjusted perceptual quality values modify a rate-distortion relationship associated with encoded video frames 404 so that quality delta 412 generated as a result of post-processor 324 is reflected in bitrate selection decisions. For example, bitrate selection module 338 can shift a rate-distortion curve associated with encoded video frames 404 toward higher predicted perceptual quality at lower bitrates, thereby identifying a saturation point where additional increases in bitrate yield minimal improvements in perceptual quality. Bitrate selection module 338 can also recompute convex hull switching points between candidate resolutions. The convex hull represents a set of representation transition points defining when switching between bitrate and resolution combinations yields a meaningful improvement in perceptual quality relative to bandwidth cost. By recomputing the convex hull using the adjusted perceptual quality values, bitrate selection module 338 identifies saturation points where increasing bitrate would not significantly improve perceptual quality after device-side post-processing. The resulting rate-distortion evaluation enables ABR engine 332 to avoid unnecessary increases in bitrate once the perceptual quality ceiling associated with post-processing has been reached.

In some embodiments, predictive model 244 is not utilized, and endpoint device 115 instead uses device quality profile 242 to determine perceptual quality adjustments associated with candidate representations. In such embodiments, device quality profile 242 provides device-specific perceptual quality values derived from profiling data, including one or more of quality delta 412 as lookup values, information corresponding to post-processing aware rate-distortion curves, information corresponding to saturation points, information corresponding to a quality ceiling, and/or partition information associated with states of endpoint device 115 and streaming attributes 502. ABR engine 332, via quality adjustment module 336 and bitrate selection module 338, utilizes information from device quality profile 242 to determine adjusted perceptual quality values for candidate representations, identify saturation behavior, and select bitrate and resolution 504 for streaming without requiring execution of predictive model 244.

Streaming application 119 then requests encoded video frames 404 corresponding to selected bitrate and resolution 504 from a content delivery network, for example using adaptive streaming segment requests based on streaming manifests. Playback module 322 receives encoded video frames 404 and renders encoded video frames 404 on endpoint device 115. During rendering, post-processor 324 executes device-side post-processing operations such as artificial intelligence super resolution and other image enhancement techniques. Endpoint device 115 then displays the rendered enhanced video frames, where device-side post-processing generates improvements in perceptual quality reflected in the adjusted perceptual quality values used during bitrate selection.

In some embodiments, device quality profile 242 and predictive model 244 are not static and can be continuously updated during or between deployment workflows 500 to maintain accuracy. For example, endpoint device 115 can perform modifications to device quality profile 242 and predictive model 244 based on updated measurements obtained during streaming playback or self-test operations. DQP updater 340 can update device quality profile 242 and predictive model 244 to reflect changes in device firmware, post-processor 324 behavior, or device picture quality settings.

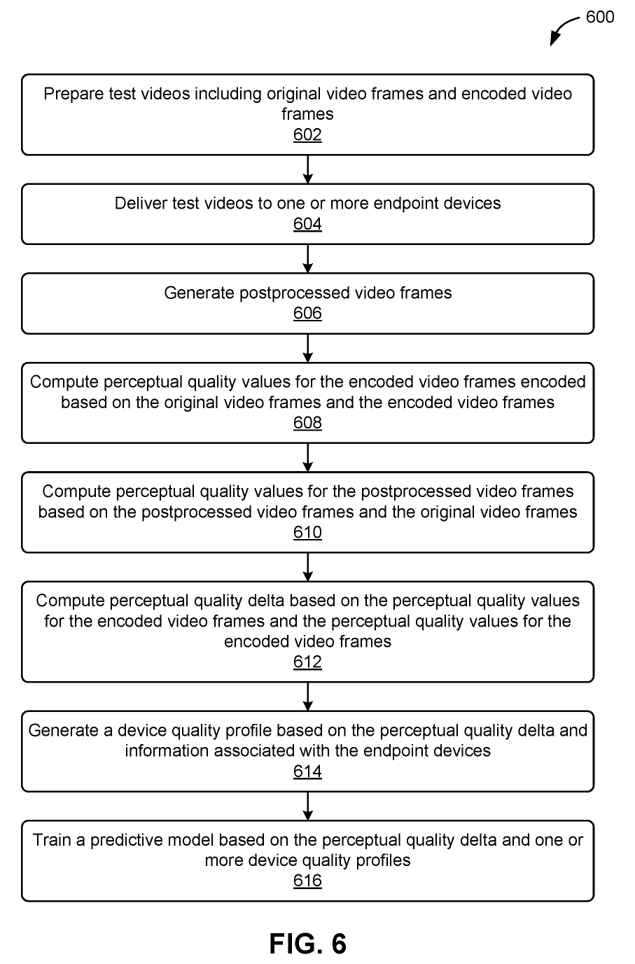

FIG. 6 illustrates a flow diagram of a method 600 for device profiling, according to various embodiments. Although the method steps are described in conjunction with the systems of FIGS. 1-5, persons skilled in the art will understand that any system configured to perform the method steps in any order is within the scope of the present disclosure.

As shown in FIG. 6, the method 600 begins at step 602, where test distribution module 222 prepares test videos that include original video frames 402 and encoded video frames 404, as described in FIGS. 1-5. At step 604, test distribution module 222 delivers the test videos to one or more endpoint devices 115 for execution of device-side processing, as described in FIGS. 1-5.

At step 606, local device profiling engine 117 generates post-processed video frames 408 by rendering the encoded video frames 404 using playback module 322 and post-processor 324 on endpoint device 115, as described in FIGS. 1-5. At step 608, quality evaluation module 224 computes perceptual quality values (e.g., encoded media VMAF values 406) for encoded video frames 404 based on a comparison between original video frames 402 and encoded video frames 404, as described in FIGS. 1-5.

At step 610, quality evaluation module 224 computes perceptual quality values (e.g., post-processed media VMAF values 410) corresponding to post-processed video frames 408 based on a comparison between post-processed video frames 408 and original video frames 402, as described in FIGS. 1-5. At step 612, quality evaluation module 224 computes quality delta 412 based on a difference between perceptual quality values for encoded video frames 404 and perceptual quality values for post-processed video frames 408 (e.g., post-processed media VMAF values 410), as described in FIGS. 1-5.

At step 614, DQP generation module 226 generates device quality profile 242 based on quality delta 412 and information associated with endpoint devices 115, as described in FIGS. 1-5. At step 616, model training module 228 trains predictive model 244 based on quality delta 412 and information stored within one or more device quality profiles 242, as described in FIGS. 1-5.

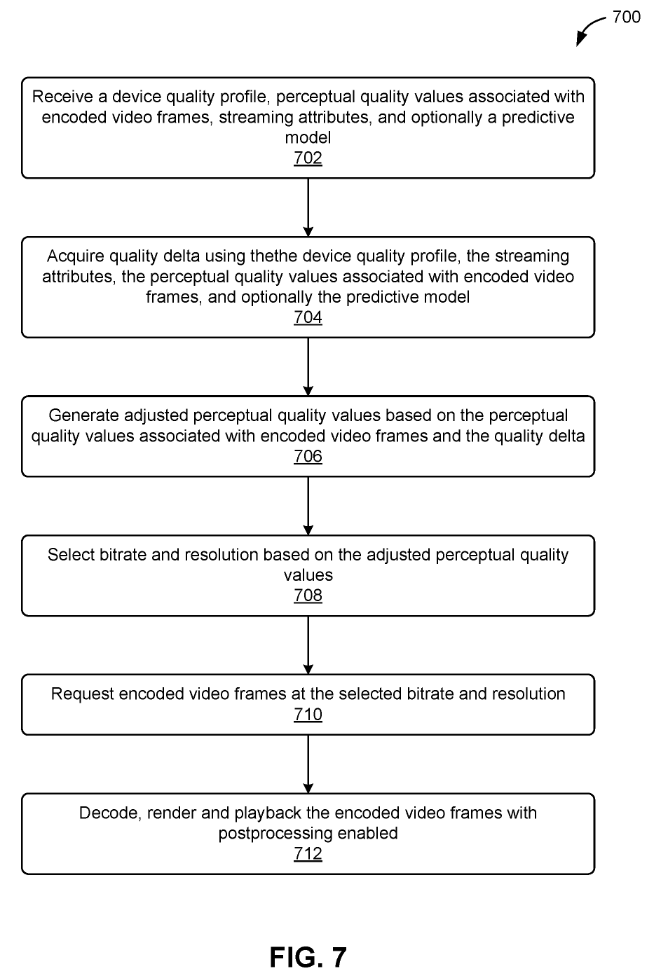

FIG. 7 illustrates a flow diagram of a method 700 for adaptive bitrate streaming using device quality profile 242, according to various embodiments. Although the method steps are described in conjunction with the systems of FIGS. 1-5, persons skilled in the art will understand that any system configured to perform the method steps in any order is within the scope of the present disclosure.

As shown in FIG. 7, the method 700 begins at step 702, where ABR engine 332 receives device quality profile 242, predictive model 244, perceptual quality values associated with encoded video frames 404 (e.g., encoded media VMAF values 406), and streaming attributes 502, as described in FIGS. 1-5. At step 706, quality adjustment module 336 generates quality delta 412 using device quality profile 242, streaming attributes 502, encoded media VMAF values 406, and optionally using predictive model 244, as described in FIGS. 1-5.

At step 708, quality adjustment module 336 generates adjusted perceptual quality values based on encoded media VMAF values 406 and quality delta 412, as described in FIGS. 1-5. At step 710, bitrate selection module 338 selects bitrate and resolution 504 based on the adjusted perceptual quality values, as described in FIGS. 1-5.

At step 712, streaming application 119 requests encoded video frames 404 corresponding to selected bitrate and resolution 504, as described in FIGS. 1-5. At step 714, playback module 322 decodes, renders, and plays back the encoded video frames 404, and post-processor 324 applies device-side post-processing, as described in FIGS. 1-5.

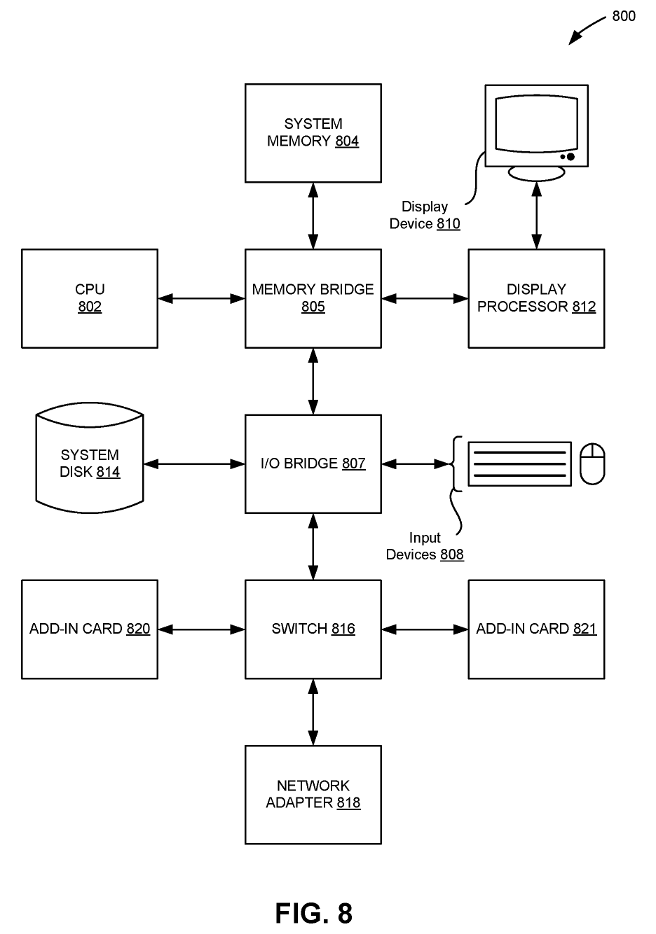

FIG. 8 is a more detailed illustration of a computing device that can implement the functionalities of any of the entities illustrated in FIG. 1, according to various embodiments. FIG. 8 in no way limits and is not intended to limit the scope of the various embodiments. In various implementations, system 800 may be an augmented reality, virtual reality, or mixed reality system or device; a personal computer; a video game console; a personal digital assistant; a mobile phone; a mobile device; or any other device suitable for practicing the various embodiments. Further, in various embodiments, any combination of two or more systems 800 may be coupled together to practice one or more aspects of the various embodiments.

As shown, system 800 includes a central processing unit (CPU) 802 and a system memory 804 that communicate via a bus path that may include a memory bridge 805. CPU 802 includes one or more processing cores, and, in operation, CPU 802 is the master processor of system 800 and controls and coordinates operations of other system components. System memory 804 stores software applications and data for use by CPU 802. CPU 802 executes software applications and optionally an operating system. Memory bridge 805, which may be, e.g., a Northbridge chip, is connected via a bus or other communication path (e.g., a HyperTransport link) to an I/O (input/output) bridge 807. I/O bridge 807, which may be, e.g., a Southbridge chip, receives user input from one or more user input devices 808 (e.g., a keyboard, mouse, joystick, digitizer tablets, touch pads, touch screens, still or video cameras, motion sensors, and/or microphones) and forwards the user input to CPU 802 via memory bridge 805.

A display processor 812 is coupled to memory bridge 805 via a bus or other communication path (e.g., a PCI Express, Accelerated Graphics Port, or HyperTransport link); in one embodiment, display processor 812 is a graphics subsystem that includes at least one graphics processing unit (GPU) and graphics memory. Graphics memory includes a display memory (e.g., a frame buffer) used for storing pixel data for each pixel of an output image. Graphics memory can be integrated in the same device as the GPU, connected as a separate device with the GPU, and/or implemented within system memory 804.

Display processor 812 periodically delivers pixels to a display device 810 (e.g., a screen or conventional CRT, plasma, OLED, SED, or LCD based monitor or television). Additionally, display processor 812 may output pixels to film recorders adapted to reproduce computer-generated images on photographic film. Display processor 812 can provide display device 810 with an analog or digital signal. In various embodiments, one or more of the various graphical user interfaces set forth in FIG. 3 are displayed to one or more users via display device 810, and one or more users can input data into and receive visual output from the various graphical user interfaces.

A system disk 814 is also connected to I/O bridge 807 and may be configured to store content, applications, and data for use by CPU 802 and display processor 812. System disk 814 provides non-volatile storage for applications and data and may include fixed or removable hard disk drives, flash memory devices, and CD-ROM, DVD-ROM, Blu-ray, HD-DVD, or other magnetic, optical, or solid-state storage devices.

A switch 816 provides connections between I/O bridge 807 and other components such as a network adapter 818 and various add-in cards 820 and 821. Network adapter 818 allows system 800 to communicate with other systems via an electronic communications network and may include wired or wireless communication over local area networks and wide area networks such as the Internet.

Other components (not shown), including USB or other port connections, film recording devices, and the like, may also be connected to I/O bridge 807. For example, an audio processor may be used to generate analog or digital audio output from instructions and/or data provided by CPU 802, system memory 804, or system disk 814. Communication paths interconnecting the various components shown in FIG. 8 may be implemented using any suitable protocols, such as PCI (Peripheral Component Interconnect), PCI Express (PCI-E), AGP (Accelerated Graphics Port), HyperTransport, or any other bus or point-to-point communication protocol(s), and connections between different devices may use different protocols, as is known in the art.

In one embodiment, display processor 812 incorporates circuitry optimized for graphics and video processing, including, for example, video output circuitry, and constitutes a graphics processing unit (GPU). In another embodiment, display processor 812 incorporates circuitry optimized for general-purpose processing. In yet another embodiment, display processor 812 may be integrated with one or more other system elements, such as the memory bridge 805, CPU 802, and I/O bridge 807, to form a system on chip (SoC). In still further embodiments, display processor 812 is omitted and software executed by CPU 802 performs the functions of display processor 812.

Pixel data can be provided to display processor 812 directly from CPU 802. In some embodiments, instructions and/or data representing a scene are provided to a render farm or a set of server computers, each similar to system 800, via network adapter 818 or system disk 814. The render farm generates one or more rendered images of the scene using the provided instructions and/or data. The rendered images may be stored on computer-readable media in a digital format and optionally returned to system 800 for display. Similarly, stereo image pairs processed by display processor 812 may be output to other systems for display, stored on system disk 814, or stored on computer-readable media in a digital format.

Alternatively, CPU 802 provides display processor 812 with data and/or instructions defining the desired output images, from which display processor 812 generates the pixel data of one or more output images, including characterizing and/or adjusting the offset between stereo image pairs. The data and/or instructions defining the desired output images can be stored in system memory 804 or graphics memory within display processor 812. In an embodiment, display processor 812 includes 3D rendering capabilities for generating pixel data for output images from instructions and data defining the geometry, lighting, shading, texturing, motion, and/or camera parameters for a scene. Display processor 812 can further include one or more programmable execution units capable of executing shader programs, tone mapping programs, and the like.

Further, in other embodiments, CPU 802 or display processor 812 may be replaced with or supplemented by any technically feasible form of processing device configured to process data and execute program code. Such a processing device could be, for example, a central processing unit (CPU), a graphics processing unit (GPU), an application-specific integrated circuit (ASIC), a field-programmable gate array (FPGA), and so forth. In various embodiments, any of the operations and/or functions described herein can be performed by CPU 802, display processor 812, or one or more other processing devices, or any combination of the different processors.

CPU 802, the render farm, and/or display processor 812 can employ any surface or volume rendering technique known in the art to generate one or more rendered images from the provided data and instructions, including rasterization, scanline rendering, REYES or micropolygon rendering, ray casting, ray tracing, image-based rendering techniques, and/or combinations of the techniques and any other rendering or image processing techniques known in the art.

In other contemplated embodiments, system 800 may be a robot or robotic device and may include CPU 802 and/or other processing units or devices and system memory 804. In such embodiments, system 800 may or may not include other elements shown in FIG. 8. System memory 804 and/or other memory units or devices in system 800 may include instructions that, when executed, cause the robot or robotic device represented by system 800 to perform one or more operations, steps, tasks, or the like.

It will be appreciated that the system shown herein is illustrative and that variations and modifications are possible. The connection topology, including the number and arrangement of bridges, may be modified as desired. For instance, in some embodiments, system memory 804 is connected to CPU 802 directly rather than through a bridge, and other devices communicate with system memory 804 via memory bridge 805 and CPU 802. In other alternative topologies, display processor 812 is connected to I/O bridge 807 or directly to CPU 802, rather than to memory bridge 805. In still other embodiments, I/O bridge 807 and memory bridge 805 might be integrated into a single chip. The particular components shown herein are optional; for instance, any number of add-in cards or peripheral devices might be supported. In some embodiments, switch 816 is eliminated, and network adapter 818 and add-in cards 820 and 821 connect directly to I/O bridge 807.

In sum, techniques are disclosed for optimization of adaptive bitrate (ABR) streaming through incorporation of device quality profiles (DQPs) that compensate for post-processing effects in ABR streaming. A DQP is a dataset specific to one or more endpoint devices, where the DQP is generated through a device testing and profiling stage. The DQP is used to quantify and characterize perceptual quality of media content rendered with post-processing. The DQP can be used as a lookup table to retrieve perceptual information for candidate representations of encoded media content. The DQP can also be used as a source of information for generating a post-processing aware rate-distortion curve that reflects perceptual quality behavior across bitrate and resolution combinations. Furthermore, a predictive model can be generated based on profiling data from the DQP to predict a difference in perceptual quality between encoded media content as sent to an endpoint device and encoded media content as rendered with post-processing on the endpoint device for combinations of streaming attributes such as resolution, bitrate, quantization parameters, device settings, and so on.

The disclosed techniques include a device testing and profiling stage and a deployment and streaming stage. In a device testing and profiling stage, media content is rendered on endpoint devices at various bitrates and resolutions with various combinations of post-processing techniques and device settings. Perceptual quality of rendered post-processed media content is measured and compared with perceptual quality of encoded media content sent to endpoint devices. A quality delta is computed as a difference between perceptual quality of rendered post-processed media content and perceptual quality of encoded media content. Data such as quality delta, perceptual quality information, media content information, device settings, and other streaming attributes are used to generate the DQP. The data can also be aggregated and used to generate the predictive model.

In a deployment and streaming stage, the DQP and optionally the predictive model are sent to the endpoint device for incorporation into ABR streaming. The endpoint device evaluates candidate representations of streaming content based on streaming attributes that include bitrate, resolution, quantization parameter, perceptual quality values associated with the streaming content, content features, and device settings. In some embodiments, the endpoint device uses the DQP to determine perceptual quality adjustments associated with candidate representations, where such determination includes determination of a quality delta corresponding to device-side post-processing. The endpoint device combines perceptual quality values associated with the streaming content and the determined quality delta to obtain adjusted perceptual quality values. In some embodiments, the endpoint device uses the DQP to retrieve the quality delta. In some embodiments, the endpoint device derives information used to generate a post-processing aware rate-distortion curve from the DQP, where the post-processing aware rate-distortion curve enables bitrate and resolution selection. In some embodiments, the endpoint device derives saturation points for a given bitrate and quality, where saturation points support bitrate and resolution selection. In some embodiments, the endpoint device uses the predictive model to predict the quality delta based on the streaming attributes. The endpoint device selects a representation of bitrate and resolution based on the adjusted perceptual quality values and requests encoded media content corresponding to the selected representation. The endpoint device renders encoded media content using device-side post-processing and outputs rendered media content for display.

At least one technical advantage of the disclosed techniques relative to prior approaches is improved accuracy of bitrate selection and resolution selection during adaptive bitrate streaming. The disclosed techniques enable adaptive bitrate streaming to account for device-side post-processing performed by an endpoint device when evaluating perceptual quality of media content. As a result, a streaming platform can select a lower bitrate representation, a lower resolution representation, or both, while maintaining a target perceptual quality at the endpoint device. The disclosed techniques therefore improve bandwidth efficiency because a streaming platform transmits less data to achieve a desired perceptual quality. Improved bandwidth efficiency reduces load on remote computing infrastructure of the streaming platform, including reduced use of compute resources, memory resources, storage resources, and energy for preparation, processing, caching, and transmission of media content. Improved bandwidth efficiency also reduces load on an endpoint device, including reduced use of compute resources, memory resources, buffer capacity, and energy for receiving, buffering, decoding, processing, and rendering media content. In addition, reduced unnecessary selection of higher bitrate representations improves playback stability by reducing a likelihood of buffering, rebuffering, and other playback disruptions. The disclosed techniques also improve device-specific adaptation because the disclosed techniques account for variation in device-side post-processing across endpoint devices, endpoint device configurations, and endpoint device states.
1. In some embodiments, a computer-implemented method for generating perceptual quality information for one or more endpoint devices comprises: providing encoded test videos to the one or more endpoint devices; receiving post-processed video frames associated with the encoded test videos from the one or more endpoint devices; generating perceptual quality information based on at least the encoded test videos; generating device-specific perceptual quality information based on at least the post-processed video frames; generating one or more quality deltas based on at least one or more differences between the perceptual quality information and the device-specific perceptual quality information; and generating, based on at least the one or more quality deltas and device information for the one or more endpoint devices, a device quality profile for the one or more endpoint devices.
2. The computer-implemented method of clause 1, wherein the post-processed video frames are received subsequent to device-side post-processing of the encoded test videos by the one or more endpoint devices.
3. The computer-implemented method of any of clauses 1-2, wherein generating the perceptual quality information and generating the device-specific perceptual quality information include generating one or more of Video Multi-Method Assessment Fusion (VMAF) values, Video Multi-Method Assessment Fusion – No Enhancement Gain (VMAF-NEG) values, Peak Signal-to-Noise Ratio (PSNR) values, or Structural Similarity Index Measure (SSIM) values.
4. The computer-implemented method of any of clauses 1-3, wherein the encoded test videos include a plurality of encoded representations associated with at least one of different bitrates, different encoding parameters, or different resolutions.
5. The computer-implemented method of any of clauses 1-4, wherein generating the device quality profile includes associating the one or more quality deltas with bitrate-and-resolution pairs corresponding to the encoded test videos.
6. The computer-implemented method of any of clauses 1-5, wherein the device information includes one or more device settings associated with the one or more endpoint devices.
7. The computer-implemented method of any of clauses 1-6, wherein the device information includes one or more firmware versions associated with the one or more endpoint devices.
8. The computer-implemented method of any of clauses 1-7, wherein generating the device quality profile includes storing the one or more quality deltas as lookup values for candidate encoded representations.
9. The computer-implemented method of any of clauses 1-8, wherein generating the device quality profile includes generating information used to generate post-processing aware rate-distortion curves for the one or more endpoint devices.
10. The computer-implemented method of any of clauses 1-9, wherein generating the device quality profile includes generating saturation point information indicating that additional bitrate yields less than a threshold perceptual quality improvement.
11. In some embodiments, one or more non-transitory computer readable media store instructions that, when executed by one or more processors, cause the one or more processors to generate perceptual quality information for one or more endpoint devices, by performing the operations of: providing encoded test videos to the one or more endpoint devices; receiving post-processed video frames associated with the encoded test videos from the one or more endpoint devices; generating perceptual quality information based on at least the encoded test videos; generating device-specific perceptual quality information based on at least the post-processed video frames; generating one or more quality deltas based on at least one or more differences between the perceptual quality information and the device-specific perceptual quality information; and generating, based on at least the one or more quality deltas and device information for the one or more endpoint devices, a device quality profile for the one or more endpoint devices.
12. The one or more non-transitory computer readable media of clause 11, wherein generating the device quality profile includes generating the device quality profile based on at least quality deltas associated with a plurality of endpoint devices.
13. The one or more non-transitory computer readable media of any of clauses 11-12, further including generating a predictive model by training the predictive model based on at least the device quality profile, wherein the predictive model predicts one or more quality deltas associated with encoded representations of media content.
14. The one or more non-transitory computer readable media of any of clauses 11-13, wherein generating the predictive model includes training the predictive model using training data that includes streaming attributes associated with the encoded representations of the media content and the one or more quality deltas.
15. The one or more non-transitory computer readable media of any of clauses 11-14, wherein the streaming attributes include at least one of bitrate, resolution, quantization parameters, perceptual quality information, device settings, or content features.
16. The one or more non-transitory computer readable media of any of clauses 11-15, wherein the post-processed video frames are received subsequent to device-side post-processing of the encoded test videos by the one or more endpoint devices.
17. The one or more non-transitory computer readable media of any of clauses 11-16, wherein generating the perceptual quality information and generating the device-specific perceptual quality information include generating one or more of Video Multi-Method Assessment Fusion (VMAF) values, Video Multi-Method Assessment Fusion – No Enhancement Gain (VMAF-NEG) values, Peak Signal-to-Noise Ratio (PSNR) values, or Structural Similarity Index Measure (SSIM) values.
18. The one or more non-transitory computer readable media of any of clauses 11-17, wherein the encoded test videos include a plurality of encoded representations associated with at least one of different bitrates, different encoding parameters, or different resolutions.
19. The one or more non-transitory computer readable media of any of clauses 11-18, wherein generating the device quality profile includes associating the one or more quality deltas with bitrate-and-resolution pairs corresponding to the encoded test videos.
20. In some embodiments, a computer system comprises one or more memories that include instructions, and one or more processors that are coupled to the one or more memories and that, when executing the instructions, generate perceptual quality information for one or more endpoint devices, by performing the operations of: providing encoded test videos to the one or more endpoint devices; receiving post-processed video frames associated with the encoded test videos from the one or more endpoint devices; generating perceptual quality information based on at least the encoded test videos; generating device-specific perceptual quality information based on at least the post-processed video frames; generating one or more quality deltas based on at least one or more differences between the perceptual quality information and the device-specific perceptual quality information, and generating, based on at least the one or more quality deltas and device information for the one or more endpoint devices, a device quality profile for the one or more endpoint devices.
21. In some embodiments, a computer-implemented method for selecting a representation of media content by an endpoint device comprises: receiving a device quality profile associated with the endpoint device; obtaining perceptual quality information associated with a plurality of encoded representations of the media content; determining, based on at least the device quality profile and the perceptual quality information, device-specific perceptual quality information for at least one encoded representation of the plurality of encoded representations; selecting, based on at least the device-specific perceptual quality information, a selected encoded representation from the plurality of encoded representations; and requesting encoded media content corresponding to the selected encoded representation.
22. The computer-implemented method of clause 21, wherein determining the device-specific perceptual quality information includes determining one or more quality deltas associated with the at least one encoded representation based on at least the device quality profile.
23. The computer-implemented method of any of clauses 21-22, wherein determining the device-specific perceptual quality information further includes generating adjusted perceptual quality values for the at least one encoded representation based on at least the one or more quality deltas and the perceptual quality information.
24. The computer-implemented method of any of clauses 21-23, wherein determining the device-specific perceptual quality information includes obtaining information used to generate a post-processing aware rate-distortion curve associated with the endpoint device from the device quality profile.
25. The computer-implemented method of any of clauses 21-24, wherein the selected encoded representation is selected based on at least the post-processing aware rate-distortion curve.
26. The computer-implemented method of any of clauses 21-25, wherein determining the device-specific perceptual quality information includes obtaining saturation point information associated with the endpoint device from the device quality profile.
27. The computer-implemented method of any of clauses 21-26, wherein selecting the selected encoded representation includes avoiding selection of an encoded representation having a higher bitrate based on at least the saturation point information indicating that additional bitrate yields less than a threshold amount of perceptual quality improvement.
28. The computer-implemented method of any of clauses 21-27, wherein the device quality profile includes measured quality deltas associated with a plurality of bitrate and resolution combinations.
29. The computer-implemented method of any of clauses 21-28, wherein the device quality profile includes information associated with at least one of one or more device settings, one or more content features, bitrate, resolution, one or more quantization parameters, or perceptual quality information.
30. The computer-implemented method of any of clauses 21-29, further including receiving a predictive model associated with the device quality profile.
31. In some embodiments, one or more non-transitory computer readable media store instructions that, when executed by one or more processors, cause the one or more processors to select a representation of media content by an endpoint device, by performing the operations of: receiving a device quality profile associated with the endpoint device; obtaining perceptual quality information associated with a plurality of encoded representations of the media content; determining, based on at least the device quality profile and the perceptual quality information, device-specific perceptual quality information for at least one encoded representation of the plurality of encoded representations; selecting, based on at least the device-specific perceptual quality information, a selected encoded representation from the plurality of encoded representations; and requesting encoded media content corresponding to the selected encoded representation.
32. The one or more non-transitory computer readable media of clause 31, further including receiving a predictive model associated with the device quality profile.
33. The one or more non-transitory computer readable media of any of clauses 31-32, wherein the predictive model is generated using profiling data associated with one or more device quality profiles.
34. The one or more non-transitory computer readable media of any of clauses 31-33, further including generating, using the predictive model, one or more predicted quality deltas associated with one or more candidate encoded representations of the media content.
35. The one or more non-transitory computer readable media of any of clauses 31-34, wherein generating the one or more predicted quality deltas includes inputting streaming attributes associated with the one or more candidate encoded representations and the endpoint device into the predictive model.
36. The one or more non-transitory computer readable media of any of clauses 31-35, further including causing the encoded media content to be rendered on a display device with which the endpoint device is communicatively coupled.
37. The one or more non-transitory computer readable media of any of clauses 31-36, wherein determining the device-specific perceptual quality information includes determining one or more quality deltas associated with the at least one encoded representation based on at least the device quality profile.
38. The one or more non-transitory computer readable media of any of clauses 31-37, wherein determining the device-specific perceptual quality information further includes generating adjusted perceptual quality values for the at least one encoded representation based on at least the one or more quality deltas and the perceptual quality information.
39. The one or more non-transitory computer readable media of any of clauses 31-38, wherein determining the device-specific perceptual quality information includes obtaining information used to generate a post-processing aware rate-distortion curve associated with the endpoint device from the device quality profile.
40. In some embodiments, a computer system comprises one or more memories that include instructions, and one or more processors that are coupled to the one or more memories and that, when executing the instructions, select a representation of media content by an endpoint device, by performing the operations of: receiving a device quality profile associated with the endpoint device; obtaining perceptual quality information associated with a plurality of encoded representations of the media content; determining, based on at least the device quality profile and the perceptual quality information, device-specific perceptual quality information for at least one encoded representation of the plurality of encoded representations; selecting, based on at least the device-specific perceptual quality information, a selected encoded representation from the plurality of encoded representations, and requesting encoded media content corresponding to the selected encoded representation.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general-purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for selecting a representation of media content by an endpoint device, the method comprising:
receiving a device quality profile associated with the endpoint device;
obtaining perceptual quality information associated with a plurality of encoded representations of the media content;
determining, based on at least the device quality profile and the perceptual quality information, device-specific perceptual quality information for at least one encoded representation of the plurality of encoded representations;
selecting, based on at least the device-specific perceptual quality information, a selected encoded representation from the plurality of encoded representations; and
requesting encoded media content corresponding to the selected encoded representation.

2. The computer-implemented method of claim 1, wherein determining the device-specific perceptual quality information includes determining one or more quality deltas associated with the at least one encoded representation based on at least the device quality profile.

3. The computer-implemented method of claim 2, wherein determining the device-specific perceptual quality information further includes generating adjusted perceptual quality values for the at least one encoded representation based on at least the one or more quality deltas and the perceptual quality information.

4. The computer-implemented method of claim 1, wherein determining the device-specific perceptual quality information includes obtaining information used to generate a post-processing aware rate-distortion curve associated with the endpoint device from the device quality profile.

5. The computer-implemented method of claim 4, wherein the selected encoded representation is selected based on at least the post-processing aware rate-distortion curve.

6. The computer-implemented method of claim 1, wherein determining the device-specific perceptual quality information includes obtaining saturation point information associated with the endpoint device from the device quality profile.

7. The computer-implemented method of claim 6, wherein selecting the selected encoded representation includes avoiding selection of an encoded representation having a higher bitrate based on at least the saturation point information indicating that additional bitrate yields less than a threshold amount of perceptual quality improvement.

8. The computer-implemented method of claim 1, wherein the device quality profile includes measured quality deltas associated with a plurality of bitrate and resolution combinations.

9. The computer-implemented method of claim 1, wherein the device quality profile includes information associated with at least one of one or more device settings, one or more content features, bitrate, resolution, one or more quantization parameters, or perceptual quality information.

10. The computer-implemented method of claim 1, further including receiving a predictive model associated with the device quality profile.

11. One or more non-transitory computer readable media storing instructions that, when executed by one or more processors, cause the one or more processors to select a representation of media content by an endpoint device, by performing the operations of:
receiving a device quality profile associated with the endpoint device;
obtaining perceptual quality information associated with a plurality of encoded representations of the media content;
determining, based on at least the device quality profile and the perceptual quality information, device-specific perceptual quality information for at least one encoded representation of the plurality of encoded representations;
selecting, based on at least the device-specific perceptual quality information, a selected encoded representation from the plurality of encoded representations; and
requesting encoded media content corresponding to the selected encoded representation.

12. The one or more non-transitory computer readable media of claim 11, further including receiving a predictive model associated with the device quality profile.

13. The one or more non-transitory computer readable media of claim 12, wherein the predictive model is generated using profiling data associated with one or more device quality profiles.

14. The one or more non-transitory computer readable media of claim 12, further including generating, using the predictive model, one or more predicted quality deltas associated with one or more candidate encoded representations of the media content.

15. The one or more non-transitory computer readable media of claim 14, wherein generating the one or more predicted quality deltas includes inputting streaming attributes associated with the one or more candidate encoded representations and the endpoint device into the predictive model.

16. The one or more non-transitory computer readable media of claim 11, further including causing the encoded media content to be rendered on a display device with which the endpoint device is communicatively coupled.

17. The one or more non-transitory computer readable media of claim 11, wherein determining the device-specific perceptual quality information includes determining one or more quality deltas associated with the at least one encoded representation based on at least the device quality profile.

18. The one or more non-transitory computer readable media of claim 17, wherein determining the device-specific perceptual quality information further includes generating adjusted perceptual quality values for the at least one encoded representation based on at least the one or more quality deltas and the perceptual quality information.

19. The one or more non-transitory computer readable media of claim 11, wherein determining the device-specific perceptual quality information includes obtaining information used to generate a post-processing aware rate-distortion curve associated with the endpoint device from the device quality profile.

20. A computer system, comprising:
one or more memories that include instructions; and
one or more processors that are coupled to the one or more memories and, when executing the instructions, select a representation of media content by an endpoint device, by performing the operations of:
receiving a device quality profile associated with the endpoint device;
obtaining perceptual quality information associated with a plurality of encoded representations of the media content;
determining, based on at least the device quality profile and the perceptual quality information, device-specific perceptual quality information for at least one encoded representation of the plurality of encoded representations;
selecting, based on at least the device-specific perceptual quality information, a selected encoded representation from the plurality of encoded representations; and
requesting encoded media content corresponding to the selected encoded representation.
